(19) United States
(12) Patent Application Publication
(10) Pub. No.: US 2025/0047570 A1
(43) Pub. Date: Feb. 6, 2025

(54) FIRST NODE, SECOND NODE, THIRD NODE, FOURTH NODE AND METHODS PERFORMED THEREBY FOR HANDLING DATA

(71) Applicant: Telefonaktiebolaget LM Ericsson (publ), Stockholm (SE)

(72) Inventors: Konstantinos VANDIKAS, Solna (SE); Abdulrahman ALABBASI, Kista (SE); Hossein SHOKRI GHADIKOLAEI, TÄBY (SE); Ramamurthy BADRINATH, Bangalore KARNATAKA (IN); Athanasios KARAPANTELAKIS, SOLNA (SE)

(73) Assignee: Telefonaktiebolaget LM Ericsson (publ), Stockholm (SE)

(21) Appl. No.: 18/718,679

(22) PCT Filed: Mar. 2, 2022
(86) PCT No.: PCT/EP2022/055322

§ 371 Date: Jun. 11, 2024

(30) Foreign Application Priority Data
Dec. 13, 2021 (GR) 20210100871

(51) Int. Cl. H04L 41/16; H04L 1/22; H04L 41/0686; H04W 24/02

(52) U.S. Cl. CPC H04L 41/16; H04L 1/22; H04L 41/0686; H04W 24/02

(57) ABSTRACT

A method by a first node (111) for handling data. The first node (111) obtains (204) one or more first sets of data corresponding to one or more first features used in a first predictive machine learning, ML, model. The data is annotated with an indication. The indication indicates a respective representation of a distribution of the data. The obtaining (204) is performed before the data are used to train the first ML model. The first node (111) determines (205) whether there has been a change in a respective representation of the distribution of the data, before the data are used to train the first ML model. The first node (111) determines (206) whether to send the data and sends (207) a second indication of the data to a third node (113) in response to the determining (206).

### TECHNICAL FIELD

The present disclosure relates generally to a first node and methods performed thereby for handling data. The present disclosure also relates generally to a second node, and methods performed thereby, for handling data. The present disclosure also relates generally to a third node, and methods performed thereby, for handling data. The present disclosure also relates generally to a fourth node, and methods performed thereby, for handling data.

### BACKGROUND

Computer systems in a communications network or system may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g., a Radio Base Station (RBS), which sometimes may be referred to as e.g., Fifth Generation (5G) Node B (gNB), evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also comprise network nodes which may serve receiving nodes, such as user equipments, with serving beams.

User Equipments (UEs) within the communications network may be e.g., wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the user equipment. The expression Uplink (UL) may be used for the transmission path in the opposite direction i.e., from the wireless device to the base station.

3GPP networks are currently witnessing the introduction of Machine Learning (ML) models, with a growing number of use cases being introduced [1]. Such ML models may be typically trained outside of a live 3GPP network using offline historical data from the same operator or from a network of another operator. As such, they may inherit and capture whatever “bias” may exist in such datasets. Herein, the term bias may be understood to refer to an existence of certain input features originating from different counters, e.g., performance monitor, configuration data and key performance indicators, whose data distribution may affect one or more target variables. After the training process is complete, these ML models may be tasked to run in a 3GPP network, which may be different than the one that was used to train the original ML model. In such cases, it may be possible that the aforementioned properties do not hold. For example, certain counters may be disabled. In this case, an empty value may be typically returned. In another example, over time, certain input parameters may no longer relate to the target variable. Also, the volume of data that may be being collected may vary overtime due to different reasons, such as failures in the data collection process.

Since a 3GPP network is not aware that such information is crucial to building an ML model, the network cannot identify such problematic cases, letting the ML models assume that everything is as expected on the data input side, and allowing the ML models to be trained with data that has low quality, and also to perform inference with such data.

Such problems may be typically solved with the introduction of data quality mechanisms that may need to be implemented manually on a model-by-model basis. Table 1 provides an overview of data quality checks that may be performed in existing models and provides an overview of such mechanisms.

TABLE 1

| | | |
|---|---|---|
| constraint | arguments | semantic |

dimension completeness

| | | |
|---|---|---|
| isComplete | column | check that there are no |
| | | missing values in a column |
| hasCompleteness | column, udf | custom validation of the |
| | | fraction of missing values |
| | | in a column |

dimension consistency

| | | |
|---|---|---|
| isUnique | column | check that there are no |
| | | duplicates in a column |
| hasUniqueness | column, udf | custom validation of the |
| | | unique value ratio in a column |
| hasDistinctness | column, udf | custom validation of the |
| | | unique row ratio in a column |
| isInRange | column, value | validation of the fraction of |
| | range | values that are in a valid |
| | | range |
| hasConsistentType | column | validation of the largest |
| | | fraction of values that have |
| | | the same type |
| isNonNegative | column | validation whether all values |
| | | in a numeric column are non- |
| | | negative |
| isLessThan | column pair | validation whether values in |
| | | the 1s column are always |
| | | less than in the 2nd column |
| | | satisfies predicate validation |
| | | whether all rows match |
| | | predicate |
| satisfiesIf | predicate pair | validation whether all rows |
| | | matching 1st predicate also |
| | | match 2nd predicate |
| hasPredictability | column, | user-defined validation of the |
| | column(s), udf | predictability of a column |

statistics (can be used to verify dimension consistency)

| | | |
|---|---|---|
| hasSize | udf | custom validation of the |
| | | number of records |
| hasTypeConsistency | column, udf | custom validation of the |
| | | maximum fraction of values |
| | | of the same data type |
| hasCountDistinct | column | custom validation of the |
| | | number of distinct non-null |
| | | values in a column |
| hasApproxCountDistinct | column, udf | custom validation of the |
| | | approx. number of distinct |
| | | non-null values |
| hasMin | column, udf | custom validation of a |
| | | column's minimum value |
| hasMax | column, udf | custom validation of a |
| | | column's maximum value |
| hasMean | column, udf | custom validation of a |
| | | column's mean value |
| hasStandardDeviation | column, udf | custom validation of a |
| | | column's standard deviation |
| hasApproxQuantile | column, | custom validation of a |
| | quantile, udf | particular quantile of a |
| | | column (approx.) |
| hasEntropy | column, udf | custom validation of a |
| | | column's entropy |
| hasMutualInformation | column pair, | custom validation of a |
| | udf | column pair's mutual |
| | | information |
| hasHistogramValues | column, udf | custom validation of |
| | | column histogram |
| hasCorrelation | column pair, | custom validation of a |
| | udf | column pair's correlation |

time

| | | |
|---|---|---|
| hasNoAnomalies | metric, | validation of anomalies in |
| | detector | time series of metric values |

In addition, degradation in the performance of ML models due to low quality data may be monitored via concept drift detection mechanisms and explainability.

Existing methods of generating ML models may result in ML models with low accuracy and thus poor predictability value.

### SUMMARY

As part of the development of embodiments herein, one or more challenges with the existing technology will first be identified and discussed.

The main issue with the approaches outlined in the Background section to manage the training of ML models with data that has low quality is that such data quality checks are typically performed in an a-posteriori fashion, after the ML model may have been trained with poor data and may have made bad predictions. This may be understood to have a potential to cause a great impact on the performance of the 3GPP network that may rely on such predictions.

Moreover, data quality mechanisms may be typically implemented outside of the 3GPP networks and may take effect only after all data may have been transferred to the entity training the ML model. This may be understood to mean that low-quality data may have already been collected from several data sources in the network, which may put a strain in the overall network communication due to the overhead caused.

According to the foregoing, it is an object of embodiments herein to improve the handling of data in a communications system.

According to a first aspect of embodiments herein, the object is achieved by a computer-implemented method, performed by a first node. The method is for handling data. The first node operates in a communications system. The first node obtains, from a second node operating in the communications system, one or more first sets of data. The one or more first sets of data correspond to one or more first features. The one or more first features are used in a first predictive ML model. The first predictive ML model is of an event measured in the communications system 100. The one or more first features are used in the first predictive ML model to explain a first variability of the event. The data in the one or more first sets of data is annotated with a first indication. The first indication indicates a respective representation of a distribution of the data in the one or more first sets of data. The obtaining is performed before the one or more first sets of data are used to train the first predictive ML model. The second node is a producer of the one or more first sets of data. The first node determines, based on the first indication, whether or not there has been a change. The change is in a respective representation of the distribution of the obtained one or more first sets of data. The change is with respect to one or more second sets of data previously collected. The one or more second sets of data correspond to the one or more first features used in the first predictive ML model. The one or more second sets of data have been used to train the first predictive ML model. The determining is performed before the one or more first sets of data are used to train the first predictive ML model. The first node also determines whether or not to send the one or more first sets of data to a third node. The third node operates in the communications system. The first node also determines whether or not to send the one or more first sets of data in response to the determining whether or not there has been a change in the respective representation of the distribution. The first node then sends a second indication of the one or more first sets of data to the third node. The sending of the second indication is in response to the determining of whether or not to send the one or more first sets of data.

According to a second aspect of embodiments herein, the object is achieved by a computer-implemented method, performed by the second node. The method is for handling data. The second node operates in the communications system. The second node obtains a fourth indication from the first node. The first node operates in the communications system. The fourth indication instructs the second node to collect the one or more first sets of data. The second node then sends, to the first node, the one or more first sets of data. The sending is performed before the one or more first sets of data are used to train any predictive ML model. The second node is the producer of the one or more first sets of data. The data in the one or more first sets of data is annotated with the first indication. The first indication indicates the respective representation of the distribution of the data in the one or more first sets of data.

According to a third aspect of embodiments herein, the object is achieved by a computer-implemented method, performed by the third node. The method is for handling data. The third node operates in the communications system. The third node obtains, from the first node operating in the communications system, the second indication. The second indication comprises at least one of the following. According to a first option, the second indication comprises the one or more first sets of data. The one or more first sets of data correspond to the one or more first features. The one or more features are used in the first predictive ML model of the event measured in the communications system to explain the first variability of the event. The data in the one or more first sets of data are annotated with the first indication. The first indication indicates the respective representation of the distribution of the data in the one or more first sets of data. The obtaining is performed before the one or more first sets of data are used to train the first predictive ML model. According to a second option, the second indication comprises the respective flag. The respective flag indicates there has been a change in the respective representation of the distribution of the obtained one or more first sets of data. The change is with respect to the one or more second sets of data previously collected. The one or more second sets of data correspond to the one or more first features. The one or more second sets of data have been used to train the first predictive ML model. According to a third option, the second indication comprises a metric indicating the change in the respective representation of the distribution. The third node retrains, using ML, the first predictive ML model based on the obtained second indication.

According to a fourth aspect of embodiments herein, the object is achieved by a computer-implemented method, performed by a fourth node. The method is for handling data. The fourth node operates in the communications system. The fourth node sends, to the third node operating in the communications system, a second predictive ML model of an expected respective representation of a distribution of data sets corresponding to the one or more first features used in the first predictive ML model. The first predictive ML model is of the event measured in the communications system to explain the first variability of the event. The fourth node obtains, from the third node, a sixth indication. The sixth indication indicates the following. First, the sixth indication comprises a source of a respective IP packet, first signal or second signal, and a destination of the respective IP packet, of one or more IP packets, first signal or second signal, in the first indication. The first indication indicates an obtained respective representation of the distribution of data in the one or more first sets of data. The one or more first sets of data correspond to the one or more first features. The data in the one or more first sets of data are annotated with the first indication. The one or more first sets of data comprise the respective flag. The respective flag indicates there has been a change. The change is in the respective representation of the distribution of the obtained one or more first sets of data. The change is with respect to the one or more second sets of data previously collected. The one or more second sets of data correspond to the one or more first features. The one or more second sets of data have been used to train the first predictive ML model. Second, the sixth indication comprises the second predictive ML model. Third, the sixth indication comprises second features of the second predictive ML model explaining most of a second variability of the expected respective representation of the distribution of data sets corresponding to the one or more first features, based on a threshold. Fourth, the sixth indication comprises a corresponding respective representation of a distribution data of the second features explaining most of the second variability, based on the threshold. The fourth node retrains, using ML, the second predictive ML model based on the obtained sixth indication.

According to a fifth aspect of embodiments herein, the object is achieved by the first node, for handling data. The first node is configured to operate in the communications system. The first node is further configured to the first node configured to, obtain, from the second node configured to operate in the communications system, the one or more first sets of data. The one or more first sets of data are configured to correspond to the one or more first features configured to be used in the first predictive ML model of the event. The event is configured to be measured in the communications system. The one or more first features are configured to be used in the first predictive ML model to explain the first variability of the event. The data in the one or more first sets of data are configured to be annotated with the first indication. The first indication is configured to indicate the respective representation of the distribution of the data in the one or more first sets of data. The obtaining is configured to be performed before the one or more first sets of data are configured to be used to train the first predictive ML model. The second node is configured to be the producer of the one or more first sets of data. The first node is further configured to determine, based on the first indication, whether or not there has been a change. The change is in the respective representation of the distribution of the one or more first sets of data configured to be obtained. The change is with respect to the one or more second sets of data configured to be previously collected. The one or more second sets of data are configured to correspond to the one or more first features configured to be used in the first predictive ML model. The one or more second sets of data are configured to have been used to train the first predictive ML model. The determining is configured to be performed before the one or more first sets of data are configured to be used to train the first predictive ML model. The first node is further configured to determine whether or not to send the one or more first sets of data to the third node. The third node is configured to operate in the communications system. The first node is configured to determine whether or not to send the one or more first sets of data in response to the determining of whether or not there has been a change in the respective representation of the distribution. The first node is further configured to send the second indication of the one or more first sets of data to the third node. The first node is further configured to send the second indication in response to the determining of whether or not to send the one or more first sets of data.

According to a sixth aspect of embodiments herein, the object is achieved by the second node, for handling data. The second node is configured to operate in the communications system. The second node is further configured to obtain the fourth indication from the first node. The first node is configured to operate in the communications system. The fourth indication is configured to instruct the second node to collect the one or more first sets of data. The second node is also configured to send, to the first node, the one or more first sets of data. The sending is configured to be performed before the one or more first sets of data are used to train any predictive ML model. The second node is configured to be the producer of the one or more first sets of data. The data in the one or more first sets of data is configured to be annotated with the first indication. The first indication is configured to indicate the respective representation of the distribution of the data in the one or more first sets of data.

According to a seventh aspect of embodiments herein, the object is achieved by the third node, for handling data. The third node is configured to operate in the communications system. The third node is configured to obtain, from the first node configured to operate in the communications system, the second indication. The second indication is configured to comprise at least one of the following. According to a first option, the second indication is configured to comprise the one or more first sets of data. The one or more first sets of data may be configured to correspond to the one or more first features configured to be used in the first predictive ML model. The first predictive ML mode is of the event configured to be measured in the communications system. The one or more first features are configured to be used in the first predictive ML model to explain the first variability of the event. The data in the one or more first sets of data may be configured to be annotated with the first indication. The first indication may be configured to indicate the respective representation of the distribution of the data in the one or more first sets of data. The obtaining may be configured to be performed before the one or more first sets of data may be configured to be used to train the first predictive ML model. According to a second option, the second indication may be configured to comprise the respective flag. The respective flag may be configured to indicate there has been a change in the respective representation of the distribution of the one or more first sets of data configured to be obtained. The change is with respect to the one or more second sets of data configured to have been previously collected. The one or more second sets of data may be configured to correspond to the one or more first features. The one or more second sets of data may be configured to have been used to train the first predictive ML model. According to a third option, the second indication may be configured to comprise the metric. The metric is configured to indicate the change in the respective representation of the distribution. The third node 113 is also configured to retrain, using ML, the first predictive ML model based on the second indication configured to be obtained.

According to an eighth aspect of embodiments herein, the object is achieved by the fourth node, for handling data. The fourth node is configured to operate in the communications system. The fourth node is configured to send, to the third node configured to operate in the communications system, the second predictive ML model. The second predictive ML model is of the expected respective representation of the distribution of data sets configured to correspond to the one or more first features. The one or more first features are configured to be used in the first predictive ML model of the event configured to be measured in the communications system to explain the first variability of the event. The fourth node is also configured to obtain, from the third node, the sixth indication. The sixth indication is configured to indicate the following. The sixth indication is configured to indicate the source of the respective IP packet, first signal or second signal, and the destination of the respective IP packet, of the one or more IP packets, first signal or second signal, in the first indication. The first indication is configured to indicate the respective representation configured to be obtained of the distribution of data in the one or more first sets of data. The one or more first sets of data are configured to correspond to the one or more first features. The data in the one or more first sets of data is configured to be annotated with the first indication. The one or more first sets of data are configured to comprise a respective flag. The respective flag is configured to indicate there has been a change in the respective representation of the distribution of the obtained one or more first sets of data. The change is with respect to the one or more second sets of data configured to have been previously collected. The one or more second sets of data are configured to correspond to the one or more first features. The one or more second sets of data are configured to have been used to train the first predictive ML model. The sixth indication is also configured to indicate the second predictive ML model. The sixth indication is further configured to indicate the second features of the second predictive ML model. The second features are configured to explain most of the second variability of the expected respective representation of the distribution of data sets configured to correspond to the one or more first features, based on the threshold. The sixth indication is also configured to indicate the corresponding respective representation of the distribution data of the second features configured to explain most of the second variability, based on the threshold. The fourth node is also configured to retrain, using ML, the second predictive ML model based on the sixth indication configured to be obtained.

By obtaining the one or more first sets of data annotated with the first indication, the first node may be enabled to obtain, e.g., view or process, the data distribution of the one or more first features as the one or more first features may be collected from the second node.

By obtaining the first indication from the second node, the first node, which may be a scheduler of each router, may thus be enabled to assess the quality of the data collected by the second node, and then prioritize different packets or signals accordingly, based on feature importance and/or expected data distribution. Furthermore, the first node may be enabled to notify any detected changes ahead of time, before such information may reach the third node, e.g., an Operations, Administration and Maintenance (OAM) or Network Data Analytics Function (NWDAF) entities in a 3GPP network but also in other types of networks such as public/private infrastructures, for further processing.

By the first node determining whether or not there has been a change in the respective representation of the distribution of the obtained one or more first sets of data, with respect to the one or more second sets of data previously collected, based on the first indication, the first node may be enabled to perform a quality control of the data being collected by the second node, before the data may be transmitted further within the communications system. The first node may be enabled to detect if packets or signals being transferred may have the expected data quality in terms of data distribution. The first node may be thereby enabled to decide on how and when to transfer collected data. For example, by performing this action, the first node may be enabled to address any inherent bias in the data sets.

By the first node determining whether or not to send the one or more first sets of data in response to whether or not there has been a change in the respective representation of the distribution, the first node may be enabled to monitor the information that may be being aggregated and may thereby be enabled to prioritize or down-prioritize the transfer of such information accordingly, i.e., to prioritize the transfer of such information that may have the sufficient quality, or down-prioritize data of low quality to give way to other data aggregations that may have higher quality. For example, embodiments herein may be understood to enable prioritization of measurement reports, which may be understood to be responsible for building dataset for training/updating ML models, which may be understood to result in a network footprint reduction, and power saving in both, the second node, e.g., a UE, or another node which may be a data producer, and network nodes such as the first node.

Moreover, the first node may be enabled to flag the data as being poor, e.g., to alert the second node that e.g., there may be a hardware malfunction in its equipment, thereby enabling to effectively manage the performance of the communications system, minimizing the overhead generated.

By the first node sending the second indication in response to the determining of whether or not to send the one or more first sets of data, the first node may be enabled to only let through the data collected by the second node that may have a sufficiently high quality. The first node may thereby prevent unnecessarily wasting resources in transmitting poor quality data. Hence, the capacity of the communications system may be enhanced, and the latency reduced. As a further advantage, the accuracy of the first predictive ML model may be enhanced by ensuring that only data of sufficient quality may be used to train the first predictive ML model.

The improved handling of the data according to embodiments herein may be understood to not only enable to reduce the communication complexity and overhead in the communications system, but as a further advantage, it may enable an early data quality check, and that a better yield may be achieved when scheduling and allocating resources for training and retraining ML models.

The safer and quality-validated datasets yield may in turn enable safer network scheduling actions.

Moreover, the first node may be enabled to flag the data as being poor, e.g., to alert the third node, so that it may be aware about this issue and reschedule the training, or inference of the first predictive ML model.

By the third node obtaining the second indication from the first node and retraining the first predictive ML model accordingly, the third node may be enabled to only receive the data collected by the second node that may have a sufficiently high quality to be used to train the first predictive ML model. The first node may thereby prevent unnecessarily wasting resources in transmitting poor quality data. Hence, the capacity of the communications system may be enhanced, and the latency reduced. As a further advantage, the accuracy of the first predictive ML model may be enhanced by ensuring that only data of sufficient quality may be used to train the first predictive ML model.

Moreover, the third node may be enabled to be alerted of poor data, as indicated by the flag or the metric, so that it may be aware about this issue and reschedule the training, or inference of the first predictive ML model accordingly.

By sending the second predictive ML model to the third node, the fourth node may ultimately enable the first node to later compare the similarity between the expected distribution of the respective data sets with that of the respective data sets obtained from the second node, and thereby detect any anomalies in the data before it may be transmitted to be used as input for the first predictive ML model. That is, the fourth node may ultimately enable the first node to later assess whether or not data of the respective data sets obtained may be of sufficient quality or not, to be used as input to train the first predictive ML model of the event. By ensuring that the data used as input for the first predictive ML model is of sufficient quality, the accuracy of the first predictive ML model may then be optimized, as well as, in turn, the predictability of the event.

By obtaining the sixth indication, the fourth node may be enabled to use this input to compare the similarity between the data distribution transferred over the network, which may be a vector, with the expected distribution, and retrain the second predictive ML model to detect any anomalies in the data that may be being transmitted. In particular, by using the second predictive ML model, as opposed to making a static statistical comparison between distributions, the expected distributions may be automated, and updated continuously or periodically, as the distributions of data of the respective first features may experience changes with time. Hence, detection, and compensation may be performed for any potential drift the data may experience, and the accuracy of the first predictive ML model may be continuously optimized. The overhead of the communications system may also be continuously optimized, while enabling data traffic in order to be used as input to train and retrain the first predictive ML model of the event.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method in a third node, according to embodiments herein.

FIG. 5 is a flowchart depicting embodiments of a method in a fourth node, according to embodiments herein.

FIG. 6 is a schematic diagram depicting a non-limiting example of a Reinforcement Learning (RL) loop, as used in embodiments herein.

FIG. 7 is a signalling diagram depicting a non-limiting example of a method in a communications system, according to embodiments herein.

FIG. 8 is a signalling diagram depicting, in panel a) and panel b), another non-limiting example of a method in a communications system, according to embodiments herein.

FIG. 9 is a schematic diagram depicting a non-limiting example of an IP packet header according to embodiments herein.

FIG. 10 is a signalling diagram depicting yet another non-limiting example of a method in a communications system, according to embodiments herein.

FIG. 11 is a schematic block diagram illustrating two non-limiting examples, a) and b), of a first node, according to embodiments herein.

FIG. 12 is a schematic block diagram illustrating two non-limiting examples, a) and b), of a second node, according to embodiments herein.

FIG. 13 is a schematic block diagram illustrating two non-limiting examples, a) and b), of a third node, according to embodiments herein.

FIG. 14 is a schematic block diagram illustrating two non-limiting examples, a) and b), of a fourth node, according to embodiments herein.

### DETAILED DESCRIPTION

Certain aspects of the present disclosure and their embodiments address the challenges identified in the Background and Summary sections with the existing methods and provide solutions to the challenges discussed.

Some of the embodiments herein may be understood to overcome the challenges of the existing methods by providing a method for annotating network traffic originating from data sources that may relate to ML models. Data annotation may be understood as a process of associating a short description to a piece of data, where that piece of data may be any data structure, such as string, e.g., a set of alphanumeric values, or a packet transmitted in a network. The short description itself may be understood to usually be a very simple data structure, such as a string limited in length, while the data structure that is annotated may be arbitrarily complex. Some of the embodiments herein may also provide a data detection mechanism which may rely on such annotations and may detect if the packets or signals that may be being transferred may have the expected data quality, e.g., in terms of data distribution, which may or may not impact a training and an inference phase of an ML model.

As a summarized overview, some of the embodiments herein may be understood to relate to data quality-aware packet tagging. More particularly, to solve the problems of the existing solutions, embodiments herein may rely on data tagging mechanisms on an IP packet or core network or RAN signalling level. That is, some of the embodiments herein may rely on data annotation, e.g., IP packet or signal annotation, also referred to as tagging [2,3], as a classification problem to handle data quality metrics. This may be performed using different features from the IP header, without requiring to read the payload of the packet or different features from the core network or RAN signals.

Some of the embodiments herein may enable a network to become capable of monitoring the information that may be being aggregated and may enable to prioritize or down prioritize a transfer of such information accordingly, in order to give way to other data aggregations that may have higher quality.

Furthermore, some of the embodiments herein, over time, may also enable to train a predictive ML model which, based on historical data may enable to predict if a particular data distribution may be different from that which may be expected or not. This may be understood to advantageously replace the need for extracting the data distribution of every important feature, which may simplify the process and reduce the overhead.

Some of the embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

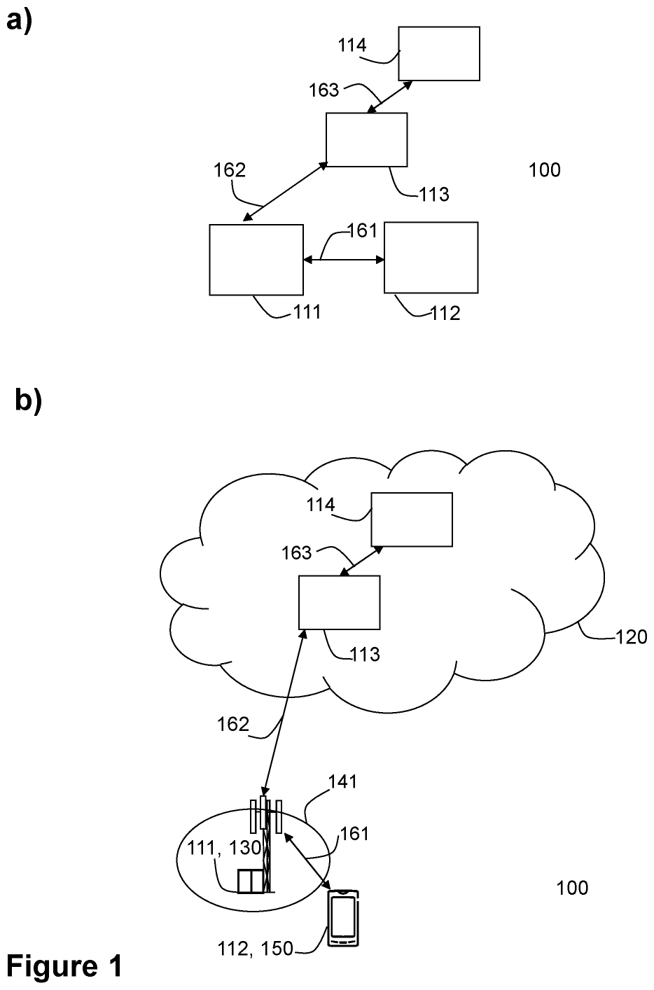

FIG. 1 depicts two non-limiting examples, in panels “a” and “b”, respectively, of a communications system 100, in which embodiments herein may be implemented. In some example implementations, such as that depicted in the non-limiting example of FIG. 1a, the communications system 100 may be a computer network. In other example implementations, such as that depicted in the non-limiting example of FIG. 1b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, e.g., 5G New Radio (NR), an LTE network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The telecommunications system may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, whereof a first node 111, a second node 112, a third node 113 and a fourth node 114 are depicted in FIG. 1. Any of the first node 111, the second node 112, the third node 113 and the fourth node 114 may be understood, respectively, as a first computer system, a second computer system, a third computer system 113 and a fourth computer system 114. In some examples, any of the first node 111, the second node 112, the third node 113 and the fourth node 114 may be implemented as a standalone server in e.g., a host computer in the cloud 120, as depicted in the non-limiting example depicted in panel b) of FIG. 1. Any of the first node 111, the second node 112, the third node 113 and the fourth node 114 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113 and the fourth node 114 may also be implemented as processing resources in a server farm.

In some embodiments, all of the first node 111, the second node 112, the third node 113 and the fourth node 114 may be independent and separated nodes. In some embodiments, any of the first node 111, the second node 112 may be one of: co-localized and the same node. In some embodiments, any of the third node 113 and the fourth node 114 may be one of: co-localized and the same node. All the possible combinations are not depicted in FIG. 1 to simplify the Figure.

It may be understood that the communications system 100 may comprise more nodes than those represented in FIG. 1.

In some examples of embodiments herein, the first node 111 may be understood as a node having a capability to gather data from a data producer of a data source. A non-limiting example of the first node 111 may be, for example, a radio network node such as the radio network node 130 described below, e.g., an eNB or gNB, a router, a packet gateways, etc.

The second node 112 may be a node having a capability to collect data, e.g., measurements. That is, the second node 112 may be understood to be a data producer of data source. A non-limiting example of the second node 112 may be, for example, a device such as the device 150 described below, e.g., a UE.

In some examples of embodiments herein, the third node 113 may be understood as a node having a capability to train a predictive ML model using ML. A non-limiting example of the third node 113 may be, for example, an OAM or a NWDAF entity in a 3GPP network, but also in other types of networks such as public/private infrastructures.

In some examples of embodiments herein, the fourth node 114 may be understood as a node having a capability to train a predictive ML model using ML. A non-limiting example of the fourth node 114 may be, for example, a Data Quality Registry (DQR) node.

The communications system 100 may comprise one or more radio network nodes, whereof a radio network node 130 is depicted in panel b) of FIG. 1. The radio network node 130 may typically be a base station or Transmission Point (TP), or any other network unit capable to serve a wireless device or a machine type node in the communications system 100. The radio network node 130 may be e.g., a 5G gNB, a 4G eNB, or a radio network node in an alternative 5G radio access technology, e.g., fixed or WiFi. The radio network node 130 may be e.g., a Wide Area Base Station, Medium Range Base Station, Local Area Base Station and Home Base Station, based on transmission power and thereby also coverage size. The radio network node 130 may be a stationary relay node or a mobile relay node. The radio network node 130 may support one or several communication technologies, and its name may depend on the technology and terminology used. The radio network node 130 may be directly connected to one or more networks and/or one or more core networks.

The communications system 100 may cover a geographical area, which in some embodiments may be divided into cell areas, wherein each cell area may be served by a radio network node, although, one radio network node may serve one or several cells. In the example of FIG. 1, the network node 130 serves a cell 141. The network node 130 may be of different classes, such as, e.g., macro eNodeB, home eNodeB or pico base station, based on transmission power and thereby also cell size. In some examples, the network node 130 may serve receiving nodes with serving beams. The radio network node may support one or several communication technologies, and its name may depend on the technology and terminology used. Any of the radio network nodes that may be comprised in the communications system 100 may be directly connected to one or more core networks.

The communications system 100 may comprise a plurality of devices whereof a device 150 is depicted in FIG. 1. The device 150 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. The device 150 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 150 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The first node 111 may communicate with the second node 112 over a first link 161, e.g., a radio link or a wired link. The first node 111 may communicate with the third node 113 over a second link 152, e.g., a radio link or a wired link. The third node 113 may communicate, directly or indirectly, with the fourth node 114 over a third link 153, e.g., a radio link or a wired link. Any of the first link 151, the second link 152 and/or the third link 153 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third” and/or “fourth” herein may be understood to be an arbitrary way to denote different elements or entities, and may be understood to not confer a cumulative or chronological character to the nouns these adjectives modify.

Although terminology from LTE/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

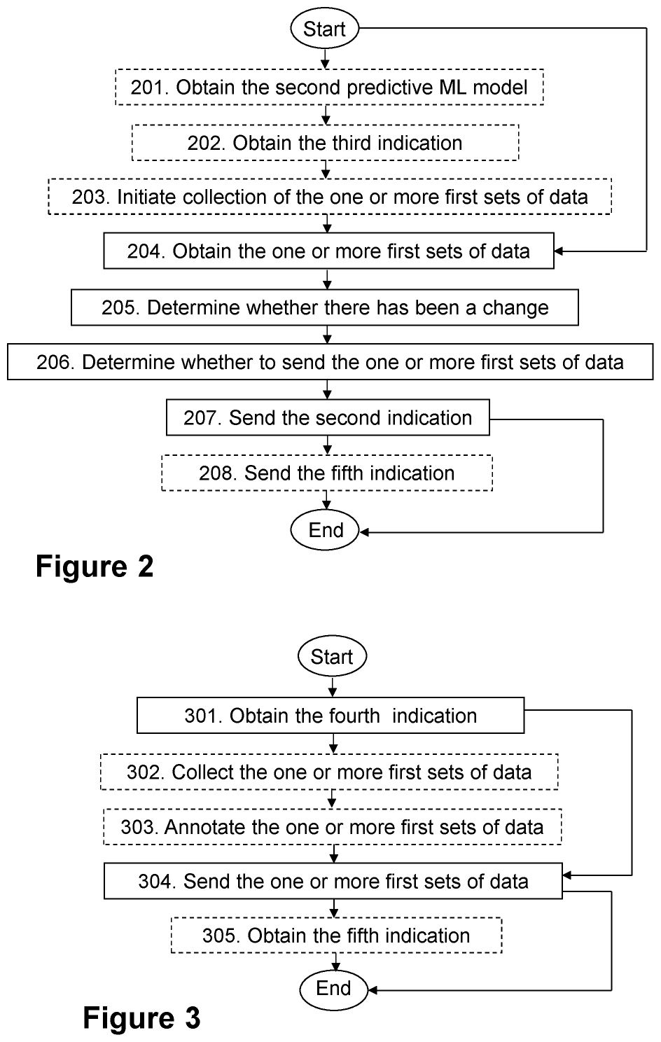

Some embodiments of a computer-implemented method, performed by the first node 111, will now be described with reference to the flowchart depicted in FIG. 2. The method may be understood to be for handling data. The first node 111 operates in the communications system 100.

In some embodiments, the wireless communications network 100 may support at least one of: NR, LTE, LTE for Machines (LTE-M), enhanced Machine Type Communication (eMTC), and Narrow Band Internet of Things (NB-IoT).

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 2. In FIG. 2, optional actions in some embodiments may be represented with dashed lines.

### Action 201

In the course of operations of the communications system 100, one or more ML models may be generated to predict events. One such ML model may be a first predictive ML model of an event measured in the communications system 100. For example, the first predictive ML model may be X=[pmRRCConnestab, pmConsumerEnergy . . . ], . . . , Y\hat{ }], which may be predictive for Physical Resource Block (PRB) utilization. In the first predictive ML model, a variability of the event “X”, referred to herein as a first variability, may be explained by one or more first features. In the illustrative example provided herein, the one or more first features may be understood to be “pmRRCConnestab”, that is, number of established RRC connections per radio equipment, and “pmConsumerEnergy”, that is, energy consumption per radio equipment. The term feature may be understood to denote independent variables or groups of independent variables treated jointly.

In order to train the first predictive ML model of the event, data for the one or more first features may need to be collected.

In order to ensure that the data that may be used to train the first predictive ML model may be of high enough quality so that the first predictive ML model may have optimal accuracy, embodiments herein may be understood to provide a data quality control mechanism before the data may be forwarded from the source onwards. The data control mechanism may comprise checking that the data collected for the one or more first features may have a distribution that may be as expected, e.g., that no outliers or drift may be present. This way, only data that passes this quality control may be enabled to be forwarded onwards and eventually used as input for the first predictive ML model.

In embodiments herein, the first node 111, e.g., an eNB, may perform the quality control, and the second node 112, e.g., a UE registered with the eNB, may be considered the data producer.

In some embodiments, the quality control based on the evaluation of the distribution of the data may be performed by using another predictive ML model. This other predictive ML model, instead of predicting the event, may be understood to predict the expected distribution of the data corresponding to the one or more features, so that the first node 111 may then be enabled to compare the observed data that may have been collected by the second node 112, that is, by the data producer, with the expected distribution. It may be understood that data respectively collected for each feature of the one or more features, may have its respective expected distribution.

According to the foregoing, in this Action 201, the first node 111 may obtain, from the third node 113, e.g., an OAM node, the other ML predictive model, which is referred to herein as a second predictive ML model. The second predictive ML model may be understood to be of an expected respective representation of a distribution of data sets corresponding to the one or more first features. As mentioned above, the one or more first features are used in the first predictive ML model of the event measured in the communications system 100, to explain the first variability of the event.

Obtaining may be understood as e.g., receiving, e.g., via the second link 162.

A data set may be understood to correspond to the set of data collected for a particular first feature of the one or more first features.

The term “representation of a distribution of data” may be understood to mean that to evaluate the distribution of data, the actual distribution of data may not be necessarily evaluated itself, but a representation may be used instead, such as by way of representation of the distribution, frequency per symbol, that is, how many times a value may appear per symbol, but also how much each distribution may fit to known distributions and then only obtaining the parameters of those. As non-limiting example, e.g., for a distribution of [0, 0, 5, 10, 5, 2], the frequency per symbol may be 0:2, 5:2, 10:1, 2:1. For example, if the distribution matches a Poisson distribution, then, in some examples, the lambda for the representation of the mass function may only be obtained, as opposed to the entire distribution of the set of data corresponding to that first feature, etc.

The second predictive ML model may have been determined by the fourth node 114, and may be based on supervised learning, e.g., via a Deep Neural Network (DNN) or reinforcement learning, e.g., via Double Deep-Q Network (DDQN). The second predictive ML model will be described in detail later, in relation to FIG. 5.

Further particularly, embodiments herein may comprise performing the method described two phases. In a first phase or phase 1, regular data collection, that is, data collection without any annotations, may be allowed to take place so that, feature importance may be identified. That is, of the one or more first features, the most relevant first features may be identified. Also, the expected data distribution for those most relevant first features may be evaluated. Once that may be captured, that association may be recorded in a look up mechanism and then, in a second phase or phase 2 the data collection requests may be associated with this information so that the first node 111 may make use of it and prioritize data transfers accordingly, as will be explained later.

A feature importance function may be used to identify important features. That is, features that may have a higher impact to the target variable than others. Such a function may utilize known techniques, such as SHAP, Shapley values, which may use a portion of input data to generate predictions and the corresponding features may be ranked by their Shapley values.

Action 201 may be understood to be an optional action. In some examples, instead of capturing the initial expectation about each data distribution from a live network, the data distribution that may have been used when training the original ML model of the first predictive ML model in a laboratory may be used. In order to use that original ML model as a baseline for ascertaining that expectation through the model's lifecycle and to determine when the baseline ML model may need to be retrained. The original ML model may be understood to refer to the very first version of the ML model that may have had high enough performance to be released. As such, it may be considered as a baseline.

By obtaining the second predictive ML model in this Action 201, the first node 111 may then be enabled to later compare the similarity between the expected distribution of the respective data sets with that of the respective data sets obtained from the second node 112 and detect any anomalies in the data before it may be transmitted to be used as input for the first predictive ML model. That is, the first node 111 may be enabled to later assess whether or not data of the respective data sets obtained may be of sufficient quality or not, to be used as input to train the first predictive ML model of the event. By ensuring that the data used as input for the first predictive ML model is of sufficient quality, the accuracy of the first predictive ML model may then be optimized, as well as, in turn, the predictability of the event. In particular, by using the second predictive ML model, as opposed to making a static statistical comparison between distributions, the expected distributions may be updated continuously or periodically, as the distributions of data of the respective first features may experience changes with time. Hence, compensation may be performed for any potential drift the data may experience.

In addition, this comparison between the expected distribution of the respective data sets with that of the respective data sets obtained may be performed using an actual expectation of a data distribution per feature, which may require a complete round-trip from data collection to data processing to be obtained. However, after enough such expectations may be accumulated, the second predictive ML model may be trained which may learn these, and as such, may be understood to not require the round-trip anymore, but instead use the ground-truth of expectations as a supervised training dataset. Therefore, there may be understood to be no need to collect the data distribution anymore when performing the checks, as the second predictive ML model may suffice. Processing, signalling and time resources, may therefore be spared.

### Action 202

In this Action 202, the first node 111 may obtain, from the third node 113, an indication. The indication obtained in this Action 202 is referred to herein as a third indication. The third indication may indicate to initiate collection of one or more first sets of data. For example, the third indication may be a get_data ( ) call to retrieve this information.

Obtaining may be understood as e.g., receiving, e.g., via the second link 162.

The one or more first sets of data correspond to the one or more first features. The one or more first features are used in the first predictive ML model of the event measured in the communications system 100 to explain the first variability of the event. The sets of data are referred to as first sets of data because they may be obtained during, e.g., a certain period of time, or during a certain number of iterations. There may be understood to be additional sets of data collected and processed in additional iterations or periods of time

This Action 202 may be understood to be an optional action which may be performed in examples wherein the third node 113 may not have a local copy of the data to train the first predictive ML model, and may then reach out to first node 111 for the needed data.

By obtaining the third indication in this Action 202, the first node 111 may then be enabled to trigger collection of the one or more first sets of data from the second node 112, that is from the data source, and thereby initiate the data collection and quality control to eventually collect data to be used as input to train the first predictive ML model.

### Action 203

In some of embodiments, in this Action 203, the first node 111 may initiate collection of the one or more first sets of data based on the obtained third indication.

In some embodiments, the initiating of the collection in this Action 203 may comprise sending another indication, which is referred to herein as a fourth indication, to the second node 112. The fourth indication may instruct the second node 112 to collect the one or more first sets of data. For example, the fourth indication may be a get_measurements ( ) request.

In some examples, the fourth indication may instruct the second node 112 to collect the one or more first sets of data wherein the data in the one or more first sets of data may be annotated. The fourth indication may instruct the second node 112 to collect the one or more first sets of data wherein the data in the one or more first sets of data may be annotated with a first indication. The first indication may have to indicate a respective representation of a distribution of the data in the one or more first sets of data. That is, to indicate the respective representation of the observed distribution of the data in the one or more first sets of data. As explained in the previous Action, this may be a frequency per symbol, a lambda for the representation of the mass function, etc. As an example, in this Action 203, the first node 111 may request the second node 112 for annotated measurements.

By initiating collection of the one or more first sets of data in this Action 203, the first node 111 may then be enabled to obtain, in the next Action 204 annotated data from the second node 112, which may then enable the first node 111 to evaluate whether or not the collected data may be of sufficient quality to be used to train the first predictive ML model of the event, thereby ensuring its optimal accuracy. Furthermore, the first node 111, may also be enabled to avoid that unnecessary overhead is generated in the communications system 100 by using resources to transmit data that may be of insufficient quality to be used for training the first predictive ML model. The first node 111 may be, e.g., a router of the second node 112, which may itself be, e.g., a UE. Hence, the capacity of the communications system 100 may be increased and the latency may be reduced.

### Action 204

In this Action 204, the first node 111 obtains, from the second node 112 operating in the communications system 100, the one or more first sets of data, e.g., corresponding to measurements. The one or more first sets of data correspond to the one or more first features. The one or more first features are used in the first predictive ML model of the event measured in the communications system 100 to explain the first variability of the event.

The data in the one or more first sets of data are annotated with the first indication. The first indication indicates a respective representation of a distribution of the data in the one or more first sets of data. As explained earlier, this may be the actual distribution, or an indication of the same, e.g., a frequency per symbol, a lambda for the representation of the mass function, etc.

Obtaining may be understood as e.g., receiving, e.g., via the first link 161.

The obtaining in Action 204 is performed before the one or more first sets of data are used to train the first predictive ML model. The second node 112 is a producer of the one or more first sets of data.

By obtaining the one or more first sets of data before the one or more first sets of data are used to train the first predictive ML model, the first node 111 enables to ensure, not only that only data having a sufficient quality is used to train the first predictive ML model, but also that resources in the communications system 100 are used more efficiently. This is because, as mentioned above, the first node 111, may be enabled to avoid that unnecessary overhead is generated using resources to transmit data that may be of insufficient quality to be used for training the first predictive ML model. Hence, the capacity of the communications system 100 may be increased and the latency may be reduced.

In some embodiments, the obtaining in this Action 204 of the one or more first sets of data may be based on the sent fourth indication. In other words, the obtaining may be in response to, or triggered by, the sent fourth indication.

The first indication may lack encapsulation. In some embodiments, the first indication may be comprised in one of: a) a field lacking encapsulation of one or more Internet Protocol (IP) packets, b) a first signal lacking encapsulation, the first signal belonging to core network signalling, c) the first signal lacking encapsulation, wherein the first signal may be a session identifier, and d) a second signal lacking encapsulation, the second signal belonging to radio access network signalling.

To illustrate the first indication comprised in the field lacking encapsulation of the one of more IP packets with a non-limiting example, a simplified internet message format such as the following may be considered, where for each packet, the following information may be provided:

A destination of a respective IP packet, e.g., as Destination
(IP address 32 (v4) or 128 bits (v6)), also mentioned as dest
A source of the respective IP packet, e.g., Source (IP address
32 (v4) or 128 bits (v6)), also mentioned as src
A protocol of the respective IP packet, e.g., Protocol (UDP/TCP)
A destination port of the respective IP packet, e.g., Destination
port (e.g., 80 Web, e.g., 25 mail), also mentioned as dest_port
A source port of the respective IP packet, e.g., Source port,
also mentioned as src_port

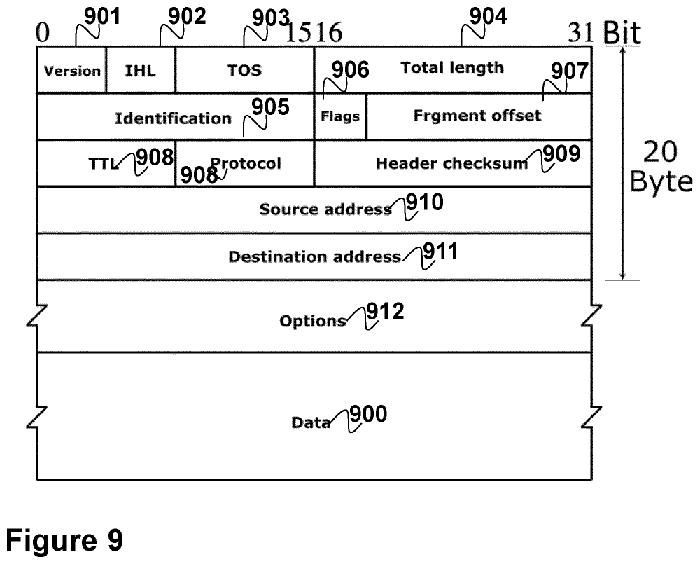

A typical IP packet header may comprise these elements along with a few additional elements, such as Options. A non-limiting example of an IP packet header according to IPv4 is shown in FIG. 9, which will be described later.

In some examples, the annotation information obtained by the first node 111 may be encoded in: an IP packet OPTION header.

In other examples, the annotation information obtained by the first node 111 may be encoded in the first signal, e.g., core control signals such as for example a Protocol Data Unit (PDU) Session, e.g., controlled by a Session Management Function (SMF) in 5G, or in the second signal, e.g., RAN control signals such as for example an rrcTransactionIdentifier which may be created when a UE may be attaching to a gNB earlier than the PDU session. An example of control signalling that may be used for transferring the annotation information may be, for example, the radio resource control (RRC) protocol used at the Radio Access Network (RAN). Specifically, RRC measurement reports may be used to transfer annotations for measurement features related to signal quality, e.g., Reference Signal Received Power (RSRP)/Reference Signal Received Quality (RSRQ).

Annotation may be understood to have taken place at the second node 112, that is, the data source. The second node 112 may be collecting data which may be, for example, some data center or a UE which may collect a set of measurements in a file, and may then transfer it over the network as-is, or compressed. When that transfer may begin, one or more IP packets, the first signal or the second signal that may belong to this transfer may be annotated with the respective representation of the data distribution of the important features from the first predictive ML model. That is, in order to decrease the overhead generated by embodiments herein, since only those features that may be important to ML models may be of interest, the collection and processing of data in embodiments herein may be further refined by tracking only those features that may have found to be relevant. That is, those first features explaining most of the first variability. “Most” may be understood to be based on a first threshold. In some examples it may be those explaining more than 50% of the variability, in others those explaining more than 60%, etc.

The one or more first features: feature 1 (f1), feature 2 (f2), feature 3 (f3), feature n (fn), etc. . . . may be understood to be represented as a set of vectors, such as:
{f1: [(10,10), (20,5), (30,20), (50,3), (60,5), . . . ], f2: [(10,35), (20,2), (30,41), (40,3), . . . ], f3, . . . fn}.

Alternatively, another way of representing the measurements of the one or more first features, that is, the one or more first sets of data, may be by using a data probability distribution and its parameters. In this case, each feature may be parameterized by the type of probability distribution and a set of parameters. For example:
{f1: {[“type”, “normal”], [u,0], [02,0,5]}, f2: {[type: “uniform”], [a, 1], [b,3]}, f3 . . . }

The set of parameters may comprise f1 to fn, which as stated above may denote the feature name, or feature identifier (id), and the array vector may contain the feature distribution.

The first indication, e.g., an options object, may give access to this information in an Object-Oriented Programming (OOP) manner.

By obtaining the one or more first sets of data annotated with the first indication in this Action 204, the first node 111 may be enabled to obtain, e.g., view or process, the data distribution of the one or more first features as the one or more first features may be collected from the second node 112. It may be understood that the first node 111 may perform this action from different data sources such as the second node 112. Whereas such information may be typically hidden inside the payload of one or more IP packets which may be being transferred from a source to a destination, according to some embodiments herein, the first indication may be advantageously comprised in the field lacking encapsulation of the IP packets, or in the first signal or the second signal lacking encapsulation. Hence, the first node 111 may be enabled to gain access to the first indication without needing to decrypt the IP packets or signals, which may be understood to enable it to process the first indication in encrypted and unencrypted traffic.

By obtaining the first indication, the first node 111, which may be a scheduler of each router, may thus be enabled to assess the quality of the data collected by the second node 112, and then prioritize different data e.g., packets, accordingly, based on feature importance and/or expected data distribution. Furthermore, the first node 111 may be enabled to notify any detected changes ahead of time, before such information reaches the third node 113, e.g., OAM or NWDAF entities in a 3GPP network but also in other types of networks such as public/private infrastructures, for further processing.

### Action 205

In this Action 205, the first node 111 determines, based on the first indication, whether or not there has been a change in the respective representation of the distribution of the obtained one or more first sets of data, with respect to one or more second sets of data previously collected. The one or more second sets of data correspond to the one or more first features used in the first predictive ML model. The one or more second sets of data have been used to train the first predictive ML model. In other words, the one or more second sets of data may be understood to correspond to data for the one or more first features, collected at e.g., an earlier time period.

The determining in this Action 205 is performed before the one or more first sets of data are used to train the first predictive ML model.

When the packets or signals may be being transferred from the second node 112, the first node 111, e.g., router, may use the reference it may have received from the third node 113, which may in fact originate from the fourth node 114, and compare these vectors with what it may be expecting. The comparison may be implemented by way of cosine similarity. A data structure which may provide the expected data distribution per feature as captured in the second predictive ML model obtained in Action 201 may be used as the reference. Cosine similarity may provide a measure of similarity between two vectors according to the following equation:

$$cos ( θ ) = \frac{A \cdot B}{‖ A ‖ ‖ B ‖}$$

The first node 111 may, in this Action 205, determine a measure of similarity between the observed and expected respective representations of the distribution of the obtained one or more first sets of data, and then flag those data having a level of change above a certain tolerance level as poor quality data. As a non-limiting example, Action 205 may be implemented according to the following algorithm:

```
similarities = [ ]
for each feature in options.features:
  sim = cosine_similarity(feature.distribution, reference[feature].distribution)
  similarities.append(sim)
flag = avg(similarities) > tolerance
```

Thereafter, by ranking the similarities that may have been produced, the corresponding packets or signals that belong to the same set of source (src), destination (dest), source port (src_port), and destination port (dest_port) may be prioritized accordingly. This may enable that, depending on how similar each feature may be with the expectation, its transmission may be differed accordingly, first transmitting the most similar features and later the least similar.

In other embodiments, other measures of similarity may be used such as Kullback-Leibler divergence and Jenson Shannon divergence.

In a different embodiment, instead of using cosine similarity, a variation of the second predictive ML model may be used to produce this ranking, see the section entitled “Supervised learning approach” under Action 501.

In some embodiments, the determining in this Action 205 of whether or not there has been a change in the respective representation of the distribution may be performed using the second predictive ML model, that is, comparing the respective representation of the distribution of the obtained one or more first sets of data with the expected respective representation of the distribution of data sets corresponding to the one or more first features, as captured by the second predictive ML model obtained in Action 201, also referred to herein as the “DQR model”, which, as stated earlier, may be based on supervised learning, e.g., via a Deep Neural Network (DNN) or reinforcement learning, e.g., via Double Deep-Q Network (DDQN).

By the first node 111 determining whether or not there has been a change in the respective representation of the distribution of the obtained one or more first sets of data, with respect to the one or more second sets of data previously collected, based on the first indication in this Action 205, the first node 111 may be enabled to perform a quality control of the data being collected by the second node 112, before the data may be transmitted further within the communications system 100. The first node 111 may be enabled to detect if data, e.g., packets, being transferred may have the expected data quality in terms of data distribution. The first node 111 may be thereby enabled to decide on how and when to transfer collected data as described in the next Action 206. For example, by performing this Action 205, the first node 111 may be enabled to address any inherent bias in the data sets. As will be further explained later, this may prevent unnecessarily wasting resources in transmitting poor quality data. Hence, the capacity of the communications system 100 may be enhanced, and the latency reduced. As a further advantage of embodiments herein, the accuracy of the first predictive ML model may be enhanced by ensuring that only data of sufficient quality may be used to train the first predictive ML model.

### Action 206

In order to decide on the prioritization of the data, e.g., to prioritize high quality data, but also to decide whether the first node 111 may want to flag the data as being poor, e.g., to alert the second node 112 that e.g., there may be a hardware malfunction in its equipment, in this Action 206, the first node 111 determines whether or not to send the one or more first sets of data to the third node 113 operating in the communications system 100. This is performed in response to the determining in Action 205 of whether or not there has been a change in the respective representation of the distribution.

The first node 111 may perform the determining in this Action 206 by considering different measures, such as if the average similarity may be above a certain threshold, or if the 95% percentile of similarities may be within a certain margin and so on.

In an alternative embodiment, the first node 111 may perform the determining in this Action 206 based on the second predictive ML model obtained in Action 201, which in some examples may follow a single-agent Deep Reinforcement Learning approach, as will be described later for the fourth node 114. Alternatively, the first node 111 may perform the determining in this Action 206 by receiving a further indication from the fourth node 114, which further indication may be a recommendation on whether or not to flag the one or more first sets of data based on an output of the second predictive ML model. The further indication may be comprised, for example, in the third indication.

By the first node 111 determining whether or not to send the one or more first sets of data in response to whether or not there has been a change in the respective representation of the distribution in this Action 206, the first node 111 may be enabled to monitor the information that may be being aggregated and may thereby be enabled to prioritize or down-prioritize the transfer of such information accordingly, to prioritize the transfer of such information that may have the sufficient quality, or down-prioritize data of low quality to give way to other data aggregations that may have higher quality. For example, embodiments herein may be understood to enable prioritization of measurement reports, which may be understood to be responsible for building datasets for training/updating models, which may be understood to result in a network footprint reduction, and power saving in both, the second node 112, e.g., a UE, or another node which may be a data producer, and network nodes such as the first node 111.

The improved handling of the data according to embodiments herein may be understood to not only enable to reduce the communication complexity and overhead in the communications system 100, but as a further advantage, it may enable an early data quality check, and that a better yield may be achieved when scheduling and allocating resources for training and retraining ML models.

Moreover, the first node 111 may be enabled to flag the data as being poor, e.g., to alert the second node 112 that e.g., there may be a hardware malfunction in its equipment, thereby enabling to effectively manage the performance of the communications system 100, minimizing the overhead generated.

The safer and quality-validated datasets yield may in turn enable safer network scheduling actions.

### Action 207

In this Action 207, the first node 111 sends a second indication of the one or more first sets of data to the third node 113 in response to the determining in Action 206 of whether or not to send the one or more first sets of data.

The sending in this Action 207 may be performed, e.g., via the second link 152.

The sending in this Action 207 may comprise at least one of the following. In some embodiments, with the proviso that there has been no change in the respective representation of the distribution of the obtained one or more first sets of data, as determined in Action 205, the sending in this Action 207 in response to the determining of whether or not to send the one or more first sets of data may comprise sending the second indication comprising the one or more first sets of data.

In some embodiments, with the proviso that there has been a change in the respective representation of the distribution due to faulty data of the obtained one or more first sets of data, the sending in this Action 207 in response to the determining of whether or not to send the one or more first sets of data may comprise refraining from sending the second indication comprising the one or more first sets of data. That is, if there is a problem on the data producer side, then the transfer of information from the data source may be suspended until that data producer may mark the issue as resolved.

In some embodiments, with the proviso that there has been a change in the respective representation of the distribution of the obtained one or more first sets of data, and the data is not faulty, the sending in this Action 207 in response to the determining of whether or not to send the one or more first sets of data may comprise sending the second indication. The second indication may comprise at least one of: i) the one or more first sets of data comprising, ii) a respective flag indicating there has been a change in the respective representation of the distribution of the obtained one or more first sets of data, e.g., a flag indicating faulty data, and iii) a metric indicating the change in the respective representation of the distribution of the obtained one or more first sets of data. In some examples, the one or more first sets of data comprising and the respective flag may be transmitted to the third node 113.

In some embodiments, the metric indicates one of: a) cosine similarity, b) Kullback-Leibler divergence and c) Jenson Shannon divergence.

In some embodiments, wherein there may have been a change in the respective representation of the distribution of the obtained one or more first sets of data, and the data may be not faulty, the one of the one or more first sets of data and the respective flag may be sent with one of: a) a lower priority than other data, and b) a delay. That is, if the data distribution has changed and there is no error on the data producer side, then this information may be down-prioritized. Its transfer may be deferred by the first node 111, since it may be understood that it is not useful to perform retraining or inference with this data. That is, the first node 111 may delay the transmission of these data to prioritize other data, e.g., packets, and flag these data.

In a different example, the flag may be propagated with high priority over the communications system 100 to indicate the issue upwards to the third node 113, so that it may be aware about this issue and reschedule the training, or inference, of the first predictive ML model.

By the first node 111 sending the second indication in response to the determining in this Action 206 of whether or not to send the one or more first sets of data, the first node 111 may be enabled to only let through the data collected by the second node 112 that may have a sufficiently high quality. The first node 111 may thereby prevent unnecessarily wasting resources in transmitting poor quality data. Hence, the capacity of the communications system 100 may be enhanced, and the latency reduced. As a further advantage, the accuracy of the first predictive ML model may be enhanced by ensuring that only data of sufficient quality may be used to train the first predictive ML model.

Moreover, the first node 111 may be enabled to flag the data as being poor, e.g., to alert the third node 113, so that it may be aware about this issue and reschedule the training, or inference of the first predictive ML model.

### Action 208

In some embodiments wherein there may have been a change in the respective representation of the distribution, due to faulty data, the first node 111 may, in this Action 208, send a fifth indication to the second node 112 indicating the detection of faulty data in the one or more first sets of data. In other words, the first node 111 may, in this Action 208, notify the data producer of the feature/dataset that may exhibit this issue. Action 208 is an optional action.

By sending the fifth indication in this Action 208, the second node 112, that is, the data producer, may thereby be enabled to perform a self-test and check if there may be something wrong on its side when it comes to collecting data.

Embodiments of a computer-implemented method, performed by the second node 112, will now be described with reference to the flowchart depicted in FIG. 3. The method may be understood to be for handling data. The second node 112 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 112 is depicted in FIG. 3. In FIG. 3, optional actions in some embodiments may be represented with dashed lines. The detailed description of some of the following corresponds to the same references provided above, in relation to the actions described for the first node 111 and will thus not be repeated here to simplify the description. For example, the second node 112 may be a UE registered with the first node 111, which may be, e.g., and eNB.

### Action 301

In this Action 301, the second node 112 obtains the fourth indication from the first node 111 operating in the communications system 100. The fourth indication instructs the second node 112 to collect the one or more first sets of data.

The obtaining, e.g., receiving, may be performed e.g., via the first link 161.

### Action 302

In this Action 302, the second node 112 may collect the one or more first sets of data based on the obtained fourth indication. That is, the collection of the one or more first sets of data may be triggered by reception of the fourth indication.

### Action 303

In this Action 303, the second node 112 may annotate the one or more first sets of data with the first indication described earlier.

In some examples, the second node 112 may be allowed to contribute to the annotation/tagging decision. For example, the annotation data may comprise, in addition to a first indicator, which may depend on the data quality, a second indicator to enable UE related Key Performance Indicators (KPIs) to be included in the decision making by the first node 111 of transmitting such measurements or packets, that is, the one or more first sets of data. Such UE KPIs may include, battery life, size of existing packets in a buffer, UL throughput, etc. In an illustrative non-limiting example, the second node 112 may then, in the next Action 304, utilize the contents of the annotations, that is, the first indication, e.g., the data quality indicator and the UE KPI indicator, to decide on sending some measurement of the one or more first sets of data based on a weighted combination of both, the data quality indicator that may have been obtained by the fourth node 114 and the UE KPI indicator. For instance, the second node 112 may run a check wherein, if the data quality indicator, e.g., a ratio between expected/unexpected distribution of data, recommends transmitting the measurement with 50% probability, the UE may then send the measurements/packets with the proviso that the contribution of UE-KPI indicator is more than e.g. 90%, and refrain from sending the measurements/packets with the proviso that the contribution of UE-KPI indicator is less than e.g. 50%.

### Action 304

In this Action 304, the second node 112 sends, to the first node 111, the one or more first sets of data. The sending is performed before the one or more first sets of data are used to train any predictive ML model. The second node 112 is the producer of the one or more first sets of data. The data in the one or more first sets of data is annotated with the first indication. The first indication indicates a respective representation of a distribution of the data in the one or more first sets of data.

The sending may be performed e.g., via the first link 161.

As described earlier, in some embodiments, the first indication may be comprised in one of: a) the field lacking encapsulation of one or more IP packets, b) the first signal lacking encapsulation, the first signal belonging to core network signalling, c) the first signal lacking encapsulation, wherein the first signal may be the session identifier, and d) the second signal lacking encapsulation, the second signal belonging to radio access network signalling.

### Action 305

In this Action 305, the second node 112 may obtain the fifth indication from the first node 111. As described earlier, the fifth indication may indicate the detection of faulty data in the one or more first sets of data.

The obtaining, e.g., receiving, may be performed e.g., via the first link 161.

After receiving the fifth indication, the second node 112 may then initiate taking an action to remedy the faulty data by e.g., performing a self-test and check if there may be something wrong on its side when it comes to collecting data.

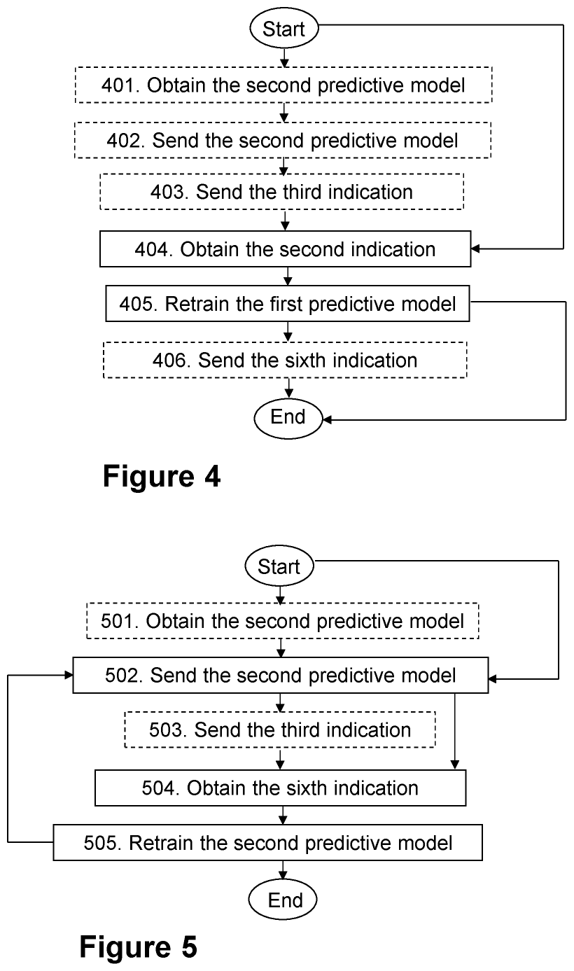

Embodiments of a computer-implemented method, performed by the third node 113, will now be described with reference to the flowchart depicted in FIG. 4. The method may be understood to be for handling data. The third node 113 operates in the communications system 100.

The method may comprise the following actions. The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third node 113 is depicted in FIG. 4. In FIG. 4, optional actions in some embodiments may be represented with dashed lines. The detailed description of some of the following corresponds to the same references provided above, in relation to the actions described for the first node 111 and will thus not be repeated here to simplify the description. For example, the one or more first features may be used in the first predictive ML model of the event measured in the communications system 100 to explain the first variability of the event.

### Action 401

In the course of operations of the communications system 100, the third node 113 may have received a blueprint for the training of the first predictive ML model. The blueprint may have been accompanied by the expected one or more first features, or names of different measurements, that may be needed as input for this ML model and the expected output. The third node 113 may then try to collect the data that may be needed to train that ML model using the expected features and the expected output that may have been declared in the ML model blueprint. In some examples, the third node 113 may have a local copy of that data. In this case it may not reach out to the first node 111 for the needed data. If the third node 113 does not have a local copy of that data it may then initiate collection of the data via the first node 111 in Action 403.

In some embodiments, the third node 113 may request a specific ML model blueprint of the second predictive ML model, that is, the data quality ML model, from the fourth node 114.

In this Action 401, the third node 113 may obtain, from the fourth node 114 operating in the communications system 100, the second predictive ML model of the expected respective representation of the distribution of data sets corresponding to the one or more first features.

The obtaining, e.g., receiving, may be performed e.g., via the third link 163.

The obtaining in this Action 401 of the second predictive ML model may be in response to the request that the third node 113 may have sent.

### Action 402

In this Action 402, the third node 113 may send the second predictive ML model to the first node 111.

The sending may be performed e.g., via the second link 162.

### Action 403

The third node 113 may already know which data sources such as the second node 112 may be used to retrieve data corresponding to each feature as defined in the ML model blueprint of the first predictive ML model. As mentioned earlier, the second node 112, the data producer, e.g., a UE, may be registered with the first node 111, e.g., an eNB.

In this Action 403, the third node 113 may send, to the first node 111, the third indication indicating to initiate collection of the one or more first sets of data.

The sending may be performed e.g., via the second link 162.

In some examples, the third node 113, or a network entity, may evaluate the importance of each of measurement of the one or more first sets of data for a specific target in a specific time frame. This step may impact the probability of such measurement, e.g., signal and/or IP packet, to be in included in the annotation, e.g., Pr(M, FI), wherein Pr may be understood to be the probability, M may be understood to be the ML model and FI may be understood to be feature importance. Accordingly, this expression may be understood to indicate the probability that a feature may be important for the given model. For example, the third node 113 may realize the temporal variation in the importance of a Timing Advance (TA) measurement on the prediction of RSRQ (target).

In another example, the third node 113, or a network entity, may evaluate the temporal change in the data distribution, or data drift, with respect to each measurement. For those measurements that may have considerable data drift, then the corresponding annotation may increase the probability to be included in the annotation vector. This step may output a probability of such measurement, e.g., signal and/or IP packet, to be in included in the annotation, e.g., Pr(M,DD), wherein Pr may be understood to be the probability, M may be understood to be the ML model and DD may be understood to be data drift. Accordingly, this expression may be understood to indicate the probability that of the data drift for the given model.

In yet another example, the third node 113, or a network entity, may evaluate the importance of the measurements or packets with respect to their impact on the network KPIs, e.g., latency, bandwidth share, energy efficiency of the network, throughput, etc. Such importance may then be reflected as a measured probability, e.g., Pr(M, NK) that may impact the data quality. For example, if this measurement may increase the network footprint more than a threshold, e.g., a third threshold, then a penalty may be included in the probability of data quality measure Pr(M,NK). Similarly, if this measurement may increase the network energy consumption more than a threshold, e.g., a fourth threshold, then a penalty may be increased in the probability of data quality measure Pr(M,NK).

### Action 404

In this Action 404, the third node 113 obtains, from the first node 111 operating in the communications system 100, the second indication. The second indication comprises at least one of the following. In some embodiments, the one or more first sets of data. The one or more first sets of data correspond to the one or more first features used in the first predictive ML model of the event measured in the communications system 100 to explain the first variability of the event. The data in the one or more first sets of data is annotated with the first indication. The first indication indicates the respective representation of the distribution of the data in the one or more first sets of data. The obtaining in this Action 404 is performed before the one or more first sets of data are used to train the first predictive ML model.

The first indication may lack encapsulation.

As described earlier, in some embodiments, the first indication may be comprised in one of: a) the field lacking encapsulation of one or more IP packets, b) the first signal lacking encapsulation, the first signal belonging to core network signalling, c) the first signal lacking encapsulation, wherein the first signal may be the session identifier, and d) the second signal lacking encapsulation, the second signal belonging to radio access network signalling.

Resources may need to be allocated on the infrastructure of the operator to retrain the first predictive ML model when the new reprioritized traffic may arrive.

In other embodiments, additionally or alternatively, the second indication may comprise the respective flag indicating there has been a change in the respective representation of the distribution of the obtained one or more first sets of data, with respect to the one or more second sets of data previously collected. The one or more second sets of data correspond to the one or more first features and the one or more second sets of data have been used to train the first predictive ML model. In other embodiments, additionally or alternatively, the second indication may comprise the metric indicating the change in the respective representation of the distribution.

As described earlier, the metric may indicate one of: a) the cosine similarity, b) the Kullback-Leibler divergence and c) the Jenson Shannon divergence.

The obtaining, e.g., receiving, may be performed e.g., via the second link 162.

In some embodiments, the obtaining in this Action 404 of the second indication may be based on the sent second predictive ML model in Action 402. This may be understood to be because the first node 111 may have used the second predictive ML model to determine, in Action 205, whether or not there has been a change in the respective representation of the distribution of the obtained one or more first sets of data, with respect to one or more second sets of data previously collected by the second node 112.

In some embodiments, the obtaining of the second indication may be based on the sent third indication in Action 403. This may be understood to be because the third indication may have triggered collection of the one or more first sets of data and the subsequent quality control analysis by the first node 111 described in relation to FIG. 2.

### Action 405

In this Action 405, the third node 113 retrains, using ML, the first predictive ML model based on the obtained second indication. This may be understood to mean that the third node 113 may retrain with one or more further iterations the first predictive ML model and recompute the input that may be needed for the fourth node 114, using the one or more first sets of data, with the proviso that the one or more first sets of data have been received, which may be understood to mean that the one or more first sets of data were of sufficient quality to be used to train the first predictive ML model. Otherwise, this may mean that the third node 113 may refrain from training the first predictive ML model, with the proviso that the flag of the metric is received instead, indicating that the data quality is too poor to be transmitted to the third node 113 and used to train the first predictive ML model.

### Action 406

If there is no problem on the side of the second node 112 that may be reported and the flagged dataset may be safely re-used for retraining the first predictive ML model, an indication that the data distribution has changed may need to be updated in the fourth node 114. In this Action 406, the third node 113 may send, to the fourth node 114, the sixth indication. The sixth indication may indicate, from the first indication, the source of the respective IP packet, first signal or second signal, and the destination of the respective IP packet, first signal or second signal. The sixth indication may further indicate the second predictive ML model. The sixth indication may also indicate second features of the second predictive ML model explaining most of a second variability of the expected respective representation of the distribution of data sets corresponding to the one or more first features based on a threshold, e.g., a second threshold. The sixth indication may further indicate a corresponding respective representation of a distribution data of the second features explaining most of the second variability, based on the threshold e.g., the second threshold.

For example, the sixth indication may be a tuple wherein the source/destination and corresponding ports, the ML model blueprint, the top features, produced from the feature importance function, and the data distribution of the top features may be assembled e.g., as <source, destination, source port, destination port, mb, top_features, data_distribution>.

The sending may be performed e.g., via the third link 163.

The second threshold may be the same, or different, than the first threshold.

By sending the sixth indication in this Action 406, the third node 113 may enable the fourth node 114 to then record the sixth indication, and use this input, to compare the similarity between the data distribution transferred over the network, which may be a vector, with the expected distribution, and train the second predictive ML model to detect any anomalies in the data that may be being transmitted.

Embodiments of a computer-implemented method, performed by the fourth node 114, will now be described with reference to the flowchart depicted in FIG. 5. The method may be understood to be for handling data. The fourth node 114 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the fourth node 114 is depicted in FIG. 5. In FIG. 5, optional actions in some embodiments may be represented with dashed lines. The detailed description of some of the following corresponds to the same references provided above, in relation to the actions described for the first node 111 and will thus not be repeated here to simplify the description. For example, the one or more first features may be used in the first predictive ML model of the event measured in the communications system 100 to explain the first variability of the event.

### Action 501

In this Action 501, the fourth node 114 may obtain, using ML, the second predictive ML model.

The obtaining may be e.g., generating, calculating, deriving and/or training.

In this Action 501, the fourth node 114, e.g., the DQR, may train the second predictive ML model that, given as input a measurement or data comprising a set of one or more second features and their data distributions, may output a decision on whether that measurement or data may be flagged or not. As mentioned earlier the second predictive ML model may be obtained via a supervised learning approach or via reinforcement learning (RL).

### Supervised Learning Approach

In this approach, the fourth node 114 may use supervised learning, e.g., via a DNN, to train the algorithm. For this approach to work, the fourth node 114 may need to first obtain a critical mass of measurements or data, from which, several data quality factors (DQF) may be calculated. These factors may contribute towards an assessment of the data quality of a measurement. The second predictive ML model may be trained using e.g., gradient descent, with a loss function based on data quality.

The next section describes how the data quality factors comprising data quality and the loss function may be calculated.

According to a first option, the data quality factors may be calculated based on a ML Model based formula. One method for calculating DQF may be probability based. For instance, according to the following first formula:
DQF=Pr(M,A)=Pr(M,FI)*Pr(M,DD)*Pr(M,NK), where Pr may be understood to be a probability, M may be understood to be the measurement or packet, FI, DD, and NK may be understood to be, respectively, Feature Importance, Data drift, and Network KPI.

In another example the DQF may be calculated according to the following second formula:
DQF=w_F*Pr(M,FI)+w_D*Pr(M,DD)+w_NK*Pr(M,NK), where w_F, w_D, and w_NK may be understood to be weights for combining density function of feature importance, data drift, and network KPI, respectively.

In yet another example, the DQF may be calculated by replacing the Pr function in the above two formulas via another contribution measure function of FI, DD, and NK.

According to a second option, the data quality factors may be calculated based on a deep NN model, that may be trained via a target or a loss function, which may contain probability and penalties of the DQF, e.g., Feature Importance, Data drift, and Network KPI. A variation of the formulas of DQF may be considered as a loss function to train the DNN in a supervised manner.

### Single-Agent Deep Reinforcement Learning Approach

In some particular embodiments, the fourth node 114 may use reinforcement learning (RL), e.g., via a DDQN, to obtain the second predictive ML model.

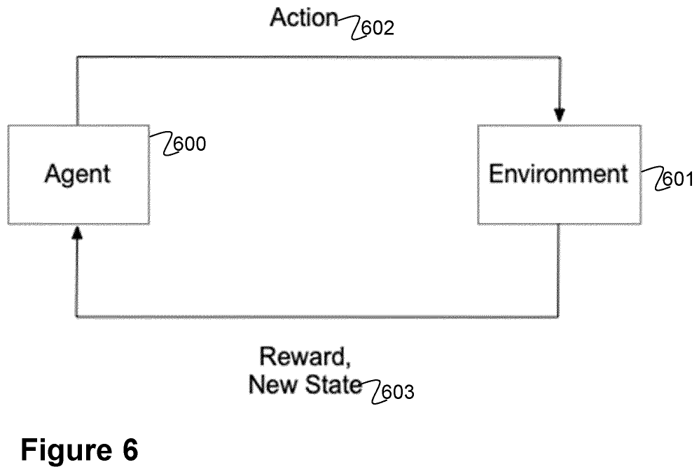

To train such an ML model, the first node 111 may perform an RL loop such as the one shown in the schematic diagram of FIG. 6. In RL, an agent 600 which may be understood to be comprised in the fourth node 114, given a state of the environment 601, may take an action 602 in this environment 601 and receive a reward and a new state 603 of the environment 601. Over time, the agent 600 may learn to take actions that may result in larger immediate and future rewards, meaning that it may be understood to be in the best interest of the agent 600 not to take the action that may only lead to the highest reward in the next state, but the action that may cumulatively lead to the highest reward in the next state and in a future number of states.

The agent 600 may comprise a neural network which may input the state and may produce an action 602. There may be several ML algorithms that may be used for training the network of the agent 600, e.g., policy-learning based such as actor-critic approaches or value-based learning such as deep-q networks.

For the single-agent RL loop described herein, the fourth node 114 may comprise both the agent entity 600 and the environment entity 601. To fully describe the RL loop, the state, action and reward elements will be now described in in greater detail.

With regards to the state space, the state may be understood to correspond to the measurements description of the one or more second features, e.g., the list of features and their data distributions.

With regards to the action space, the action may be understood to correspond to a decision on whether to flag the measurement or not, according to the description provided above. Each measurement may be data distribution of one feature of the one or more second features. Therefore, the size of the action space may be equal to 2N assuming N the number of features reported.

With regards to the reward function, the reward may be understood to correspond to be an assessment of data quality, given the state and action. The reward may be based on the calculation of a data quality Dq(F,a), wherein F may be understood to stand for data distribution of a feature, that is, part of measurement data, meaning current state of the environment, and a may stand for the action, e.g., 0 if measurement data is not flagged and 1 if measurement data is flagged. An exemplary algorithm for calculating reward R(s,a) may be as follows, given also:
flag_threshold may be understood to be a value that may indicate the level of data quality below which data may have to be flagged;
s may be understood to be the current state, that is, a list of data distribution for all features;
a may be understood to be the action, that also may comprise sub-actions for all features, e.g., a.f2. An action may be set to 0 if feature is not to be flagged, otherwise it may be set to 1.

```
Init R(s,a) = 0
Init featureCount = 0
Init tempReward = 0
For feature f in s
  If Dq(f,a.f) <= flag_threshold and a.f == 1 OR Dq(f,a.f) > flag_threshold and a.f == 0
    tempReward += 1
  featureCount++
R(s,a) = tempReward/featureCount
Data quality, Dq(f,a), may be quantified using the following metrics.
```

A first metric may be feature importance, as determined by the feature_importance function explained above. The function calculating feature importance for a packet or measurement M may be denoted as Pr(f, FI). The feature importance may be relevant and features may be ranked on a [0, 1] normalized scale, features closer to 1 being more important than others.

A second metric may be Data drift, or concept drift, which may be understood to correspond to the change of the data distribution over time. For example, if feature data distributions are assumed to be parameterized by their type, e.g., normal, pareto, etc . . . and parameters, a drift may cause the values of parameters of the data distribution to change, e.g., in case of a normal distribution parameters u, o, or in extreme cases, the type of data distribution to change, e.g., from normal to uniform.

A function Pr(f, DD) may be able to output the degree of change, penalizing more the change of type of data distribution and less the change in parameters, which may also fluctuate based on the difference between the previous and current parameter values. As per previous, the data drift value may be a normalized value belonging to [0, 1], wherein larger data drifts may be closer to 0 and more consistent measurements over time may be closer to 1.

Calculating Dq(f,a) may be a weighted average:
Dq(f,a)=(wFI*Pr(f,FI)+wDD*Pr(f,DD))/2, wherein the weights wFI and wDD may be adjusted depending on the preferences of the use case.

As far as training the algorithm itself, several algorithms from the state of art may be used. An example may be a Double Deep-Q Network (DDQN) [4]. According to DDQN, the agent may have two neural networks, a DQN trained to produce an action given a state description, and a target network, which may help to stabilize the training of the DQN.

The process may begin by the agent initializing the weights of the two neural networks either at random or using transfer learning from a baseline neural network. The latter case, may be a neural network trained in a laboratory environment, with a dataset representative of a general case that may be applicable for any agent. Subsequently, within a series of iterations, also known as episodes, the agent may take an action given a state of the environment and observe the reward for its action and the new state returned from the environment. The selection of an action may be based on a selection policy, e.g., epsilon greedy, which may balance exploration, e.g., random action choice at least in the beginning, with exploitation, e.g., execution of the DQN. The agent may store the <state, action, reward, new state> in its internal buffer and after some episodes have elapsed, it may train its neural network, e.g., using gradient descent, and a loss function of mean squared error of ground truth, e.g., provided by target network, and value of selected action.

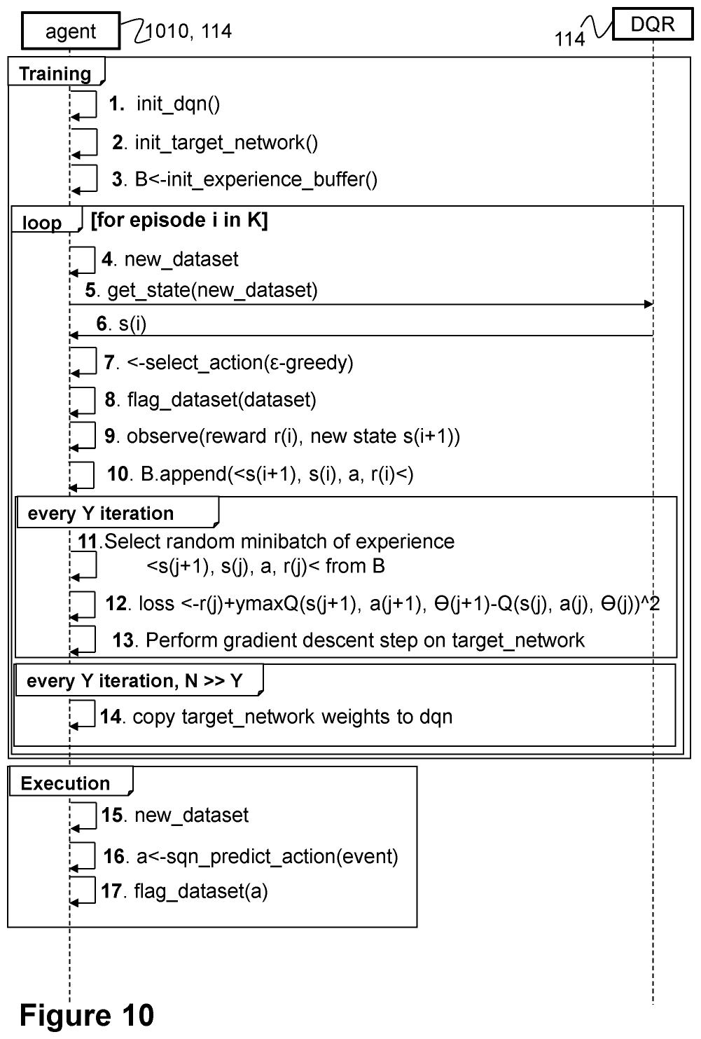

After a larger number of episodes than those for training DQN may elapse, the target network may copy the weights of the DQN. The reason for doing this after many episodes elapse, may be understood to be to deal with the non-stationarity problem during training. Specifically, the ground truth may not change in each episode as in this case the DQN may not have any consistency in learning. The overall sequence will be illustrated with a non-limiting example in FIG. 10, which will be described later.

### Action 502

In this Action 502, the fourth node 114 sends, to the third node 113 operating in the communications system 100, the second predictive ML model of the expected respective representation of the distribution of data sets corresponding to the one or more first features used in the first predictive ML model of the event measured in the communications system 100 to explain the first variability of the event.

The sending may be performed e.g., via the third link 163.

### Action 503

In this Action 503, the fourth node 114 may send, to the third node 113 the third indication indicating to initiate collection of the one or more first sets of data.

### Action 504

In this Action 504, the fourth node 114 obtains, from the third node 113, the sixth indication. The sixth indication indicates the source of a respective IP packet, first signal or second signal, and the destination of the respective IP packet, of the one or more IP packets, first signal or second signal, in the first indication. As described earlier, the first indication indicates the obtained respective representation of the distribution of data in the one or more first sets of data. The one or more first sets of data correspond to the one or more first features. The data in the one or more first sets of data are annotated with the first indication. The one or more first sets of data comprise the respective flag indicating there has been a change in the respective representation of the distribution of the obtained one or more first sets of data, with respect to the one or more second sets of data previously collected. The one or more second sets of data correspond to the one or more first features. The one or more second sets of data have been used to train the first predictive ML model.

The sixth indication also indicates the second predictive ML model.

The sixth indication further indicates the second features of the second predictive ML model explaining most of the second variability of the expected respective representation of the distribution of data sets corresponding to the one or more first features, based on the threshold, that is, the second threshold. The sixth indication also indicate the corresponding respective representation of the distribution data of the second features explaining most of the second variability, based on the threshold, that is, the second threshold.

As described earlier, in some embodiments, the first indication may be comprised in one of: a) the field lacking encapsulation of one or more IP packets, b) the first signal lacking encapsulation, the first signal belonging to core network signalling, c) the first signal lacking encapsulation, wherein the first signal may be the session identifier, and d) the second signal lacking encapsulation, the second signal belonging to radio access network signalling.

The obtaining, e.g., receiving may be performed e.g., via the third link 163.

### Action 505

In this Action 505, the fourth node 114 retrains, using ML, the second predictive ML model based on the obtained sixth indication. Once the second predictive ML model is retrained, the method may iterate going back to Action 502.

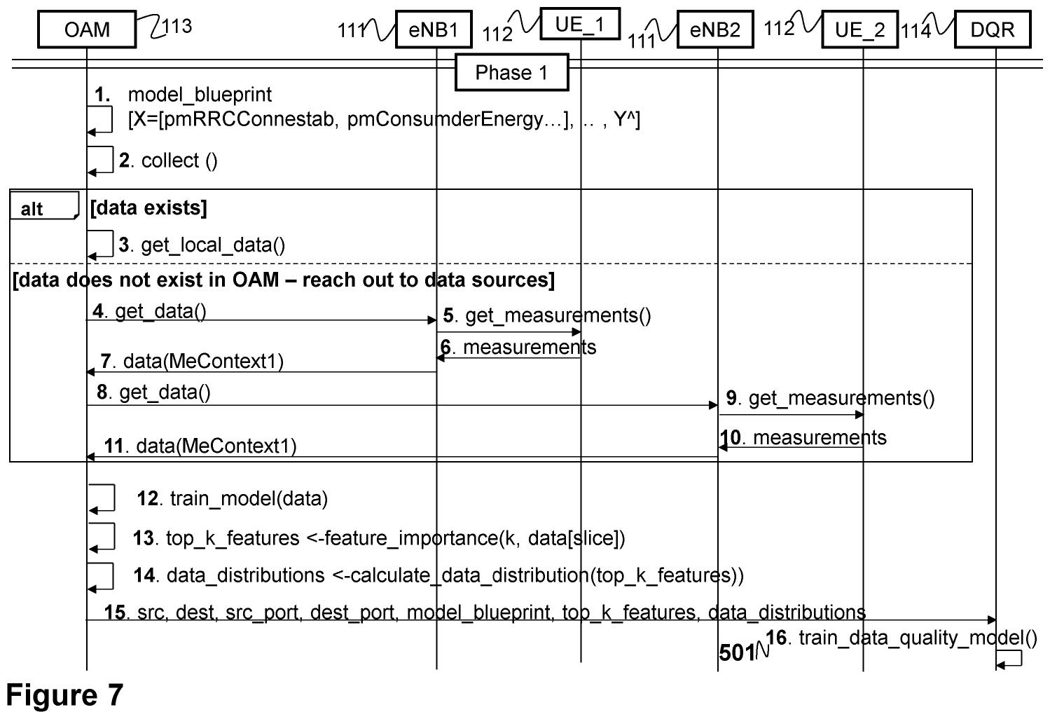

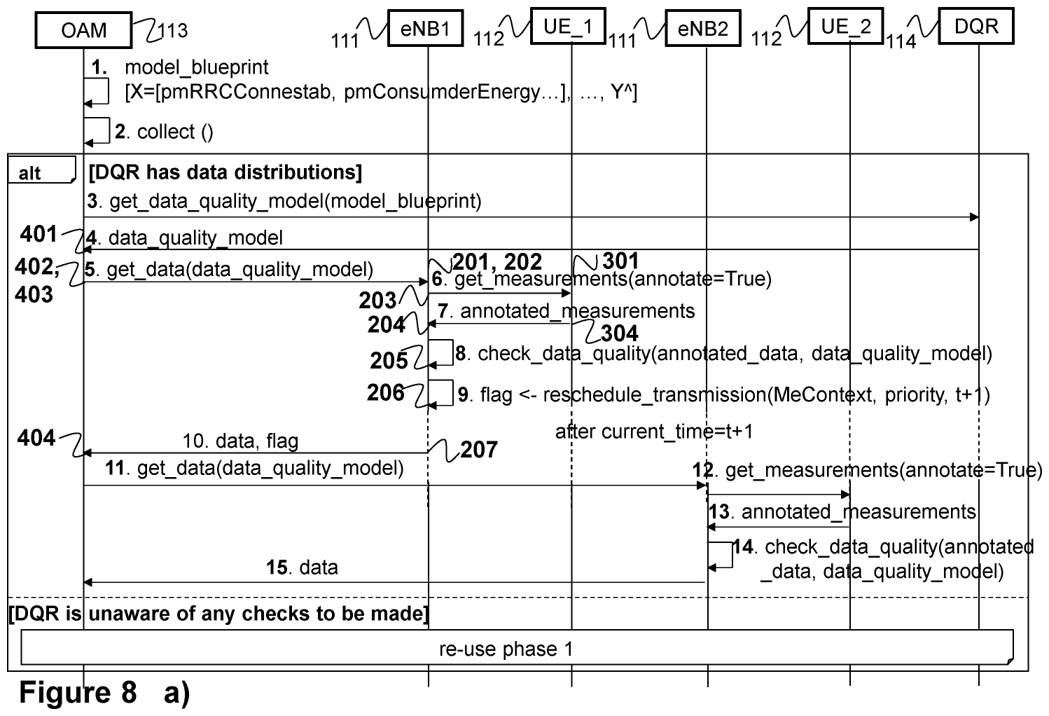

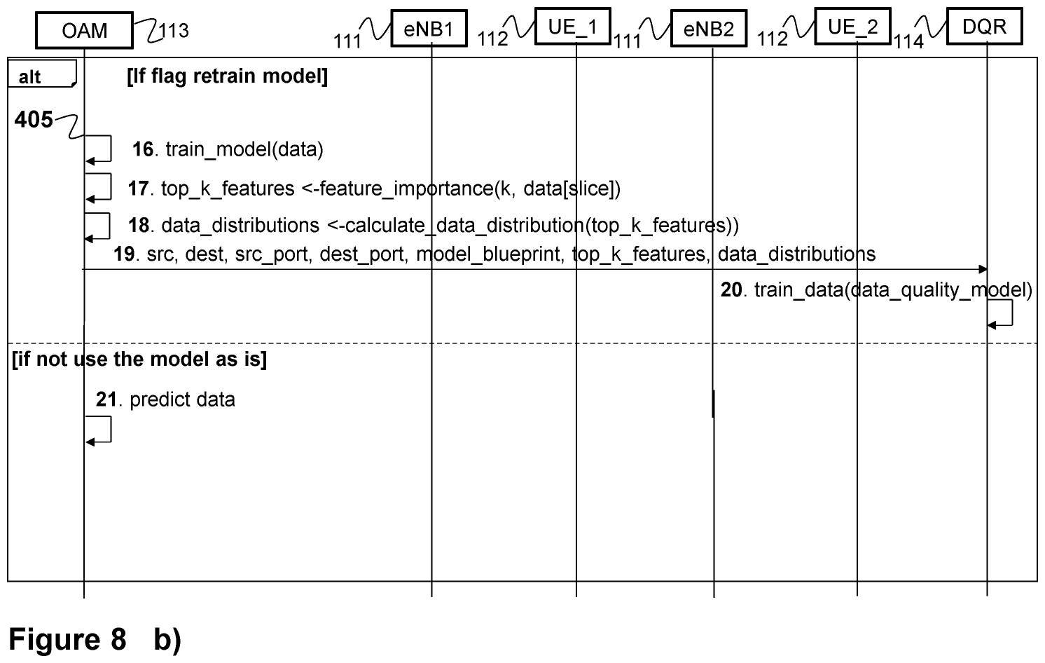

As explained earlier, the methods according to embodiments herein may operate in two phases. In phase 1, regular data collection, that is, without any annotations, may be allowed to take place, so that feature importance may be identified, but also the expected data distribution for those features may be determined. Once that may be captured, that association may be recorded in a look up mechanism and then, in phase 2 the data collection requests may be associated with this information so that one or more first network nodes such as the first node 111 may make use of it and prioritize data transfers accordingly. Each phase is illustrated accordingly in FIG. 7 and FIG. 8, as described below. In these two figures, for simplicity, a scenario is considered, where just two second nodes 112, in this examples, two UEs, UE1_1 and UE1_2, are registered to only two first nodes 111, in this examples, two eNBs, eNB1 and eNB2. In addition, it is assumed in these examples that the third node 113, in this examples, an OAM node, already knows which data sources may be used to retrieve each feature as defined in the ML model blueprint. In both examples, the fourth node 114 is a DQR node.

FIG. 7 is a signalling diagram depicting a non-limiting example of a method performed by the first node 111, the second node 112, the third node 113 and the fourth node 114 according to embodiments herein. Particularly, FIG. 7 depicts a non-limiting implementation of the methods according to Phase 1. The process begins at 1, when a blueprint for the training of the first predictive ML model is obtained by, e.g., submitted to, the third node 113. The blueprint is accompanied by the expected one or more first features, or names of different measurements, that may be needed as input for this ML model and the expected output. At 2, the third node 113 may then try to collect the data that may be needed to train that ML model using the expected features and the expected output that may have been declared in the ML model blueprint. At 3, the third node 113 may have a local copy of that data, represented as “data exists”. In this case it may not reach out to the first nodes 111, the, eNBs, for the needed data. At steps 4-11, if the third node 113 does not have a local copy of that data it may then reach out to the data sources UE_1 and UE_2, and use the get_data ( ) call to retrieve this information from eNB1 to eNB2 at Step 4 and Step 8, respectively. At Step 5 and Step 9, each of eNB1 and eNB2 may respectively instruct UE_1 and UE_2, respectively, to get the measurements. At Step 6 and Step 10, each node may respectively provide back a response, e.g., comprised of one or more IP packets, which are not annotated since in this phase such input is absent in the Data Quality Registry node. At Step 12, the third node 113 has now enough data to train the first predictive ML model which has been declared in the ML model blueprint thus fulfilling the initial purpose of this task. At Step 13, once the first predictive ML model has been trained, the feature_importance function may be used to identify important features, that is the “top k features”. That is, features that may have a higher impact to the target variable than others. Such a function may utilize known techniques, such as SHAP, Shapley values, which may use a portion of input data to generate predictions, and the corresponding features may be ranked by their Shapley values. At Step 14, the data distribution of most the important features may be calculated, since it may be desired to use it in phase 2 to perform comparisons while transferring data in the communications system 100. At Step 15, the source/destination and corresponding ports, the ML model blueprint, the top features, produced from the feature importance function, and the data distribution of the top features may be assembled in a tuple <source, destination, source port, destination port, mb, top_features, data_distribution> and may be recorded in the fourth node 114. At Step 16, using this input, the data distribution, which may be understood to be a vector, may be used to compare the similarity between the expected distribution and what may be transferred over the communications system 100 to train, according to Action 501, the second predictive ML model to detect any anomalies in the data that may be being transmitted.

FIG. 8 is another signalling diagram depicting another non-limiting example of a method performed by the first node 111, the second node 112, the third node 113 and the fourth node 114 according to embodiments herein. Particularly, FIG. 8, spreading over panel a) and panel b), depicts a non-limiting implementation of the methods according to Phase 2. In a same manner as phase 1, the process begins at 1, when a blueprint for the training of the first predictive ML model is obtained by, e.g., submitted to, the third node 113. The blueprint is accompanied by the expected one or more first features, or measurements, that may be needed as input for this ML model and the expected output. At Step 2, the third node 113 may then try to collect the data that may be needed to train that ML model using the expected features and the expected output that may have declared in the ML model blueprint. As opposed to phase 1, for illustration purposes, it may be assumed that the third node 113 does not have a local copy of that data. At Step 3, the second predictive ML model for the specific ML model blueprint may be requested from the fourth node 114. At Step 4, the fourth node 114 responds with the model, which the third node 113 obtains according to Action 401. At Step 5, the second predictive ML model is propagated, according to Action 402, Action 201 and Action 202, to the first nodes 111, e.g., eNBs, or gNBs, which may then collect measurements from the second nodes 112, e.g., the UEs, but in this case, using annotated data. In Step 6, eNB1, according to Action 203, requests UE1_1 for annotated measurements, which the second node 112 receives according to Action 301. In this case the UE may annotate the data that it may have collected according to Action 303. More details on the annotation have already been provided above. In Step 7, the second node 112, UE1_1, returns the annotated measurements according to Action 304. At Step 8, eNB1 checks the data using the second predictive ML model, according to Action 205. In this case, at Step 9, the second predictive ML model determines that there has been a change in the data distribution and as such the transmission of these data is determined to be delayed, according to Action 206, to prioritize other packets and flag these data. In a different example, the flag may be propagated with high priority over the communications system 100 to indicate the issue upwards to the third node 113, so that it may be aware about this issue and may reschedule the training, or inference, of the corresponding first predictive ML model. Accordingly, at Step 10, the data and the flag are now transmitted to the third node 113 according to Action 207 and Action 404. At Steps 11-15, the same Steps described in Step 4-10 are repeated for another first node 111, eNB2. That is, the annotated data collection process continues until Step 15. For simplicity, for UE_2, it is considered that no issues were detected by the second predictive ML model. Hence, the data is transmitted to the third node 113 in Step 15, according to Action 207 and Action 404. The reference numbers for the corresponding actions are not indicated again in this case, to avoid overcrowding the figure. In some examples, the fourth node 114 may not know the data distribution of any feature for a given model, as indicated in the figure by “DQR is unaware of any checks to be made”. In such examples, the method may fall back to phase 1 explained previously which may be understood to perform reconnaissance and identify the initial feature distribution, as indicated by “re-use phase 1” in the figure. Continuing on panel b), Step 16, is now conditioned based on the flag. If the data distribution has changed, as was detected early in the data transfer, the third node 113 may need to now retrain the first predictive ML model, according to Action 405, and recompute the input that may be needed for the fourth node 114. Step 17 may be understood to be the same as Step 13 in phase 1. Step 18 may be understood to be the same as Step 14 in phase 1. Step 19 may be understood to be the same as Step 15 in phase 1. Step 20 may be understood to be the same as Step 16 in phase 1. At Step 21, alternatively, this input may be used directly for inference purposes. In another example Step 1 may be omitted and instead of capturing the initial expectation about each data distribution from a live network, the data distribution that was used when training the original ML model in the laboratory may be used in order to use that as a baseline and thus allow for ascertaining that expectation through the lifecycle of the first predictive ML model and to determine when the first predictive ML model may need to be retrained.

FIG. 9 is a schematic representation of an IP packet header according to IPv4. The header is depicted as comprising, in addition to the data payload 900, the following fields: a version field 901, an Internet Header Length (IHL) field 902, a Type of Service (TOS) field 903, a Total length field 904, an Identification field 905, a Flags field 906, an Fragment offset field 907, a Time to Live (TTL) field 908, a Protocol field 908, a Header checksum field 909, a Source address field 910, a Destination field 911 and an Options field 912. The first indication may be comprised in the Options field, which may be understood to lack encapsulation.

FIG. 10 is a schematic representation of a non-limiting example of a method performed by the fourth node 114, in this example, a DQR node, to obtain the second predictive ML model, according to Action 501. Particularly, FIG. 10 depicts an example implementation using DDQN based tagging. The process begins by the agent 1010, which may be comprised in the fourth node 114, initializing at each of Step 1 and Step 2, the weights of two networks either at random or using transfer learning from a baseline neural network. The latter case, may be a neural network trained in a laboratory environment, with a dataset representative of a general case that may be applicable for any agent. At Step 3, the agent 1010 may initialize its experience buffer, that is, the storage space it may use to collect data from to train its neural network later in the training process. Initialization may be understood to refer to an allocation of memory for the data structure. Subsequently, within a series of iterations K, also known as episodes, the agent 1010 may, for a new dataset obtained in Step 4, take an action at Step 8 given a state of the environment requested at Step 5 and obtained at Step 6, and observe the reward for its action at Step 9 and the new state returned from the environment. The action may be understood to be here to flag the dataset, wherein the flag may be meant to denote if the dataset may need to be used for inference or for retraining the model. At Step 7, the selection of an action may be based on a selection policy, e.g., epsilon greedy, which may balance exploration, e.g., random action choice at least in the beginning, with exploitation, e.g., execution of the DQN. At Step 10, the agent 1010 may store the <state, action, reward, new state> in its internal buffer. At Step 11, the agent 1010 may select randomly a few experiences from the experience buffer, wherein each experience may be understood to be a set of <state, action, reward, new state>, and one experience may be observed in every iteration. The agent 1010 may train its neural network using a training algorithm, e.g., gradient descent, and a loss function of mean squared error between output, Q-values, of the target Q network, target_network, which may be perceived as ground truth, and the predicted Q-values of the fourth node 114. At Step 14, after a larger number of episodes than those for training DQN may elapse, the target network may copy the weights of the DQN. The reason for doing this after many episodes elapse, may be understood to be to deal with the non-stationarity problem during training. Specifically, the ground truth may not change in each episode as in this case the DQN may not have any consistency in learning. At Step 15, after a larger number, K, of episodes than those for training DQN may elapse in the training loop, the execution phase may start with a new state provided by the environment (“new dataset”). Then, at Step 16, the agent 1010 may execute its trained DQN to select an action for the given state. At Step 17, the flag may denote if the dataset may be required to be used for inference or for retraining (binary).

As a summarized overview of the foregoing, embodiments herein may be understood to provide a system that may store an expected data distribution per feature, per ML model, and may provide a mechanism for checking if incoming traffic from different data sources such as the second node 112 may correspond to the expectation or not. The latter may be achieved in three main ways, either through cosine similarity, supervised learning (DNN) or reinforcement learning (DDQN).

Certain embodiments disclosed herein may provide one or more of the following technical advantage(s), which may be summarized as follows. Embodiments herein may be understood to enable the communications system 100, e.g., a 5G system, or any other network, to decide on how and when to transfer collected data.

Embodiments herein enable to detect if packets being transferred may have the expected data quality in terms of data distribution. Embodiments herein may for example enable to address any inherent bias in the data sets. As a first advantage, this may be understood to enable an improved prediction of the first predictive ML model, by using higher quality data.

The communications system 100 may thereby become capable of monitoring the information that may be being aggregated and may prioritize or down-prioritize the transfer of such information accordingly, to prioritize the transfer of such information that may have the sufficient quality, or down-prioritize data of low quality to give way to other data aggregations that may have higher quality. For example, embodiments herein may be understood to enable prioritization of measurement reports, which may be understood to be responsible for building dataset for training/updating models, which may be understood to result in a network footprint reduction, and power saving in both, the second node 112, e.g., a UE, or another node which may be a data producer, and network nodes such as the first node 111.

The improved handling of the data according to embodiments herein may be understood to not only enable to reduce the communication complexity and overhead in the communications system 100, but as a further advantage, it may enable an early data quality check, and that a better yield may be achieved when scheduling and allocating resources for training and retraining ML models.

Furthermore, embodiments herein may advantageously enable automation of the first predictive ML model re-training process, that is, when to retrain the ML model, which may be understood to reduce the manual data quality mechanisms on a per model basis. Accordingly, embodiments herein may enable an operator to assert and maintain the performance of a ML model in production.

As a yet another advantage, embodiments herein may be understood to enable common standardization and interoperability for an observability framework. Interoperability may be understood to mean here to allow different components some residing within 3GPP others outside of 3GPP, to collaborate through a common process and/or set of interfaces. Moreover, the safer and quality-validated datasets yield according to embodiments herein may be understood to enable safer network scheduling actions.

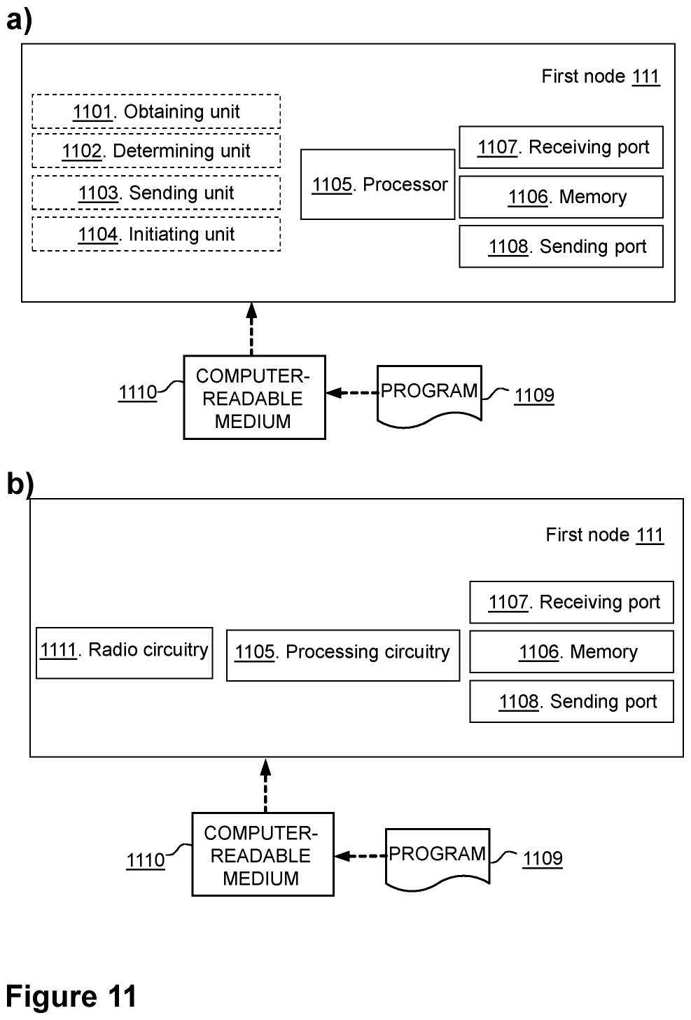

FIG. 11 depicts two different examples in panels a) and b), respectively, of the arrangement that the first node 111 may comprise to perform the method actions described above in relation to FIG. 2, and/or FIGS. 7-8. In some embodiments, the first node 111 may comprise the following arrangement depicted in FIG. 11a. The first node 111 may be understood to be for handling data. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the first node 111 and will thus not be repeated here. For example, the second node 112 may be configured to be a UE registered with the first node 111, which may be configured to be, e.g., and eNB.

The first node 111 is configured to, e.g. by means of an obtaining unit 1101 within the first node 111 configured to, obtain, from the second node 112 configured to operate in the communications system 100, the one or more first sets of data. The one or more first sets of data are configured to correspond to the one or more first features configured to be used in the first predictive ML model of the event. The event is configured to be measured in the communications system 100. The one or more first features are configured to be used in the first predictive ML model to explain the first variability of the event. The data in the one or more first sets of data are configured to be annotated with the first indication. The first indication is configured to indicate the respective representation of the distribution of the data in the one or more first sets of data. The obtaining is configured to be performed before the one or more first sets of data are configured to be used to train the first predictive ML model. The second node 112 is configured to be the producer of the one or more first sets of data.

In some embodiments, the first indication may be configured to be comprised in one of: a) the field configured to lack encapsulation of one or more IP packets, b) the first signal configured to lack encapsulation, the first signal being configured to belong to core network signalling, c) the first signal, wherein the first signal may be configured to be the session identifier, and d) the second signal configured to lack encapsulation, the second signal being configured to belong to radio access network signalling.

The first node 111 is also configured to, e.g. by means of a determining unit 1102 within the first node 111 configured to, determine, based on the first indication, whether or not there has been a change in the respective representation of the distribution of the one or more first sets of data configured to be obtained, with respect to the one or more second sets of data configured to be previously collected. The one or more second sets of data are configured to correspond to the one or more first features configured to be used in the first predictive ML model. The one or more second sets of data are configured to have been used to train the first predictive ML model. The determining is configured to be performed before the one or more first sets of data are configured to be used to train the first predictive ML model.

The first node 111 is further configured to, e.g. by means of the determining unit 1102 configured to, determine whether or not to send the one or more first sets of data to the third node 113 configured to operate in the communications system 100, in response to the determining of whether or not there has been a change in the respective representation of the distribution.

The first node 111 is further configured to, e.g. by means of a sending unit 1103 within the first node 111 configured to, send the second indication of the one or more first sets of data to the third node 113 in response to the determining of whether or not to send the one or more first sets of data.

In some embodiments, the sending may be configured to comprise at least one of the following options. According to a first option, with the proviso that there has been no change in the respective representation of the distribution of the one or more first sets of data configured to be obtained, the sending may be configured to comprise sending the second indication configured to comprise the one or more first sets of data. According to a second option, with the proviso that there has been a change in the respective representation of the distribution due to faulty data of the one or more first sets of data configured to be obtained, the sending may be configured to comprise refraining from sending the second indication configured to comprise the one or more first sets of data. According to a third option, with the proviso that there has been a change in the respective representation of the distribution of the one or more first sets of data configured to be obtained, and the data is not faulty, the sending may be configured to comprise sending the second indication. The second indication may be configured to comprise at least one of: i) the one or more first sets of data, ii) the respective flag configured to indicate there has been a change in the respective representation of the distribution of the one or more first sets of data configured to be obtained, and c) the metric configured to indicate the change in the respective representation of the distribution of the one or more first sets of data configured to be obtained.

In some embodiments, with the proviso that there has been a change in the respective representation of the distribution of the one or more first sets of data configured to be obtained, and the data is not faulty, the one of the one or more first sets of data and the respective flag may be configured to be sent with one of: a) the lower priority than other data, and b) the delay.

In some embodiments, the metric may be configured to indicate one of: a) the cosine similarity, b) the Kullback-Leibler divergence and c) the Jenson Shannon divergence.

In some embodiments, the first node 111 may be further configured to, e.g. by means of the obtaining unit 1101 within the first node 111 configured to, obtain, from the third node 113, the third indication configured to indicate to initiate collection of the one or more first sets of data.

In some embodiments, the first node 111 may be further configured to, e.g. by means of an initiating unit 1104 within the first node 111 configured to, initiate collection of the one or more first sets of data based on the third indication configured to be obtained.

In some embodiments, the initiating collection may be configured to comprise sending the fourth indication to the second node 112. The fourth indication may be configured to instruct the second node 112 to collect the one or more first sets of data. Additionally, the obtaining of the one or more first sets of data may be configured to be based on the fourth indication configured to be sent.

In some embodiments, with the proviso there has been a change in the respective representation of the distribution, due to faulty data, the first node 111 may be further configured to, e.g. by means of the sending unit 1103 within the first node 111 configured to, send the fifth indication to the second node 112 configured to indicate the detection of faulty data in the one or more first sets of data.

In some embodiments, the first node 111 may be further configured to, e.g. by means of the obtaining unit 1101 within the first node 111 configured to, obtain, from the third node 113, the second predictive ML model of the expected respective representation of the distribution of data sets configured to correspond to the one or more first features. In some of such embodiments, the determining of whether or not there has been a change in the respective representation of the distribution may be configured to be performed using the second predictive ML model.

The embodiments herein may be implemented through one or more processors, such as a processor 1105 in the first node 111 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1106 comprising one or more memory units. The memory 1106 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, and/or another node through a receiving port 1107. In some examples, the receiving port 1107 may be, for example, connected to one or more antennas in the first node 111. In other embodiments, the first node 111 may receive information from another structure in the communications system 100 through the receiving port 1107. Since the receiving port 1107 may be in communication with the processor 1105, the receiving port 1107 may then send the received information to the processor 1105. The receiving port 1107 may also be configured to receive other information.

The processor 1105 in the first node 111 may be further configured to transmit or send information to e.g., the second node 112, the third node 113, the fourth node 114, another node, and/or another structure in the communications system 100, through a sending port 1108, which may be in communication with the processor 1105, and the memory 1106.

Those skilled in the art will also appreciate that any of the units 1101-1104 described above may refer to a combination of analog and digital circuits, and/or one or more processors configured with software and/or firmware, e.g., stored in memory, that, when executed by the one or more processors such as the processor 1105, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1101-1104 described above may be the processor 1105 of the first node 111, or an application running on such processor.

Thus, the methods according to the embodiments described herein for the first node 111 may be respectively implemented by means of a computer program 1109 product, comprising instructions, i.e., software code portions, which, when executed on at least one processor 1105, cause the at least one processor 1105 to carry out the actions described herein, as performed by the first node 111. The computer program 1109 product may be stored on a computer-readable storage medium 1110. The computer-readable storage medium 1110, having stored thereon the computer program 1109, may comprise instructions which, when executed on at least one processor 1105, cause the at least one processor 1105 to carry out the actions described herein, as performed by the first node 111. In some embodiments, the computer-readable storage medium 1110 may be a non-transitory computer-readable storage medium, such as a CD ROM disc, a memory stick, or stored in the cloud space. In other embodiments, the computer program 1109 product may be stored on a carrier containing the computer program, wherein the carrier is one of an electronic signal, optical signal, radio signal, or the computer-readable storage medium 1110, as described above.

The first node 111 may comprise an interface unit to facilitate communications between the first node 111 and other nodes or devices, e.g., the second node 112, the third node 113, the fourth node 114, another node, and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 11b. The first node 111 may comprise a processing circuitry 1105, e.g., one or more processors such as the processor 1105, in the first node 111 and the memory 1106. The first node 111 may also comprise a radio circuitry 1111, which may comprise e.g., the receiving port 1107 and the sending port 1108. The processing circuitry 1105 may be configured to, or operable to, perform the method actions according to FIG. 2, and/or FIGS. 7-8, in a similar manner as that described in relation to FIG. 11a. The radio circuitry 1111 may be configured to set up and maintain at least a wireless connection with the second node 112, the third node 113, the fourth node 114, another node, and/or another structure in the communications system 100.

Hence, embodiments herein also relate to the first node 111 operative for handling fata, the first node 111 being operative to operate in the communications system 100. The first node 111 may comprise the processing circuitry 1105 and the memory 1106, said memory 1106 containing instructions executable by said processing circuitry 1105, whereby the first node 111 is further operative to perform the actions described herein in relation to the first node 111, e.g., in FIG. 2, and/or FIGS. 7-8.

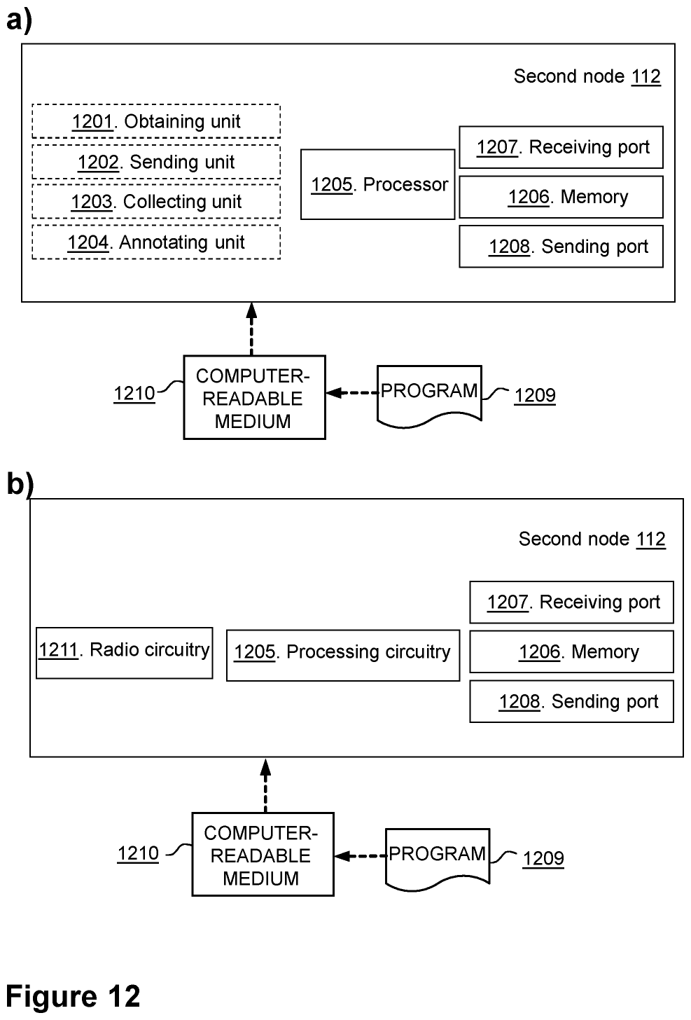

FIG. 12 depicts two different examples in panels a) and b), respectively, of the arrangement that the second node 112 may comprise to perform the method actions described above in relation to FIG. 3, and/or FIGS. 7-8. In some embodiments, the second node 112 may comprise the following arrangement depicted in FIG. 12a. The second node 112 may be understood to be for handling data. The second node 112 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the first node 111 and will thus not be repeated here. For example, the second node 112 may be configured to be a UE registered with the first node 111, which may be configured to be, e.g., and eNB.

The second node 112 is configured to, e.g. by means of an obtaining unit 1201 within the second node 112 configured to, obtain the fourth indication from the first node 111 configured to operate in the communications system 100. The fourth indication is configured to instruct the second node 112 to collect the one or more first sets of data.

The second node 112 is also configured to, e.g. by means of a sending unit 1202 within the second node 112 configured to, send, to the first node 111, the one or more first sets of data. The sending is configured to be performed before the one or more first sets of data are used to train any predictive ML model. The second node 112 is configured to be the producer of the one or more first sets of data. The data in the one or more first sets of data is configured to be annotated with the first indication. The first indication is configured to indicate the respective representation of the distribution of the data in the one or more first sets of data.

In some embodiments, the first indication may be configured to be comprised in one of: a) the field configured to lack encapsulation of one or more IP packets, b) the first signal configured to lack encapsulation, the first signal being configured to belong to core network signalling, c) the first signal, wherein the first signal may be configured to be the session identifier, and d) the second signal configured to lack encapsulation, the second signal being configured to belong to radio access network signalling.

The second node 112 may also be configured to, e.g. by means of a collecting unit 1203 within the second node 112 configured to, collect the one or more first sets of data based on the fourth indication configured to be obtained.

The second node 112 may also be configured to, e.g. by means of an annotating unit 1204 within the second node 112 configured to, annotate the one or more first sets of data with the first indication.

The second node 112 may be further configured to, e.g. by means of the obtaining unit 1201 within the second node 112 configured to, obtain the fifth indication from the first node 111. The fifth indication may be configured to indicate detection of faulty data in the one or more first sets of data.

The embodiments herein may be implemented through one or more processors, such as a processor 1205 in the second node 112 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1206 comprising one or more memory units. The memory 1206 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, and/or another node, through a receiving port 1207. In some examples, the receiving port 1207 may be, for example, connected to one or more antennas in the second node 112. In other embodiments, the second node 112 may receive information from another structure in the communications system 100 through the receiving port 1207. Since the receiving port 1207 may be in communication with the processor 1205, the receiving port 1207 may then send the received information to the processor 1205. The receiving port 1207 may also be configured to receive other information.

The processor 1205 in the second node 112 may be further configured to transmit or send information to e.g., the first node 111, the third node 113, the fourth node 114, another node, and/or another structure in the communications system 100, through a sending port 1208, which may be in communication with the processor 1205, and the memory 1206.

Those skilled in the art will also appreciate that the units 1201-1204 described above may refer to a combination of analog and digital circuits, and/or one or more processors configured with software and/or firmware, e.g., stored in memory, that, when executed by the one or more processors such as the processor 1205, perform as described above. One or more of these processors, as well as the other digital hardware, may be included in a single ASIC, or several processors and various digital hardware may be distributed among several separate components, whether individually packaged or assembled into a SoC.

The units 1201-1204 described above may be the processor 1205 of the second node 112, or an application running on such processor.

Thus, the methods according to the embodiments described herein for the second node 112 may be respectively implemented by means of a computer program 1209 product, comprising instructions, i.e., software code portions, which, when executed on at least one processor 1205, cause the at least one processor 1205 to carry out the actions described herein, as performed by the second node 112. The computer program 1209 product may be stored on a computer-readable storage medium 1210. The computer-readable storage medium 1210, having stored thereon the computer program 1209, may comprise instructions which, when executed on at least one processor 1205, cause the at least one processor 1205 to carry out the actions described herein, as performed by the second node 112. In some embodiments, the computer-readable storage medium 1210 may be a non-transitory computer-readable storage medium, such as a CD ROM disc, a memory stick, or stored in the cloud space. In other embodiments, the computer program 1209 product may be stored on a carrier containing the computer program, wherein the carrier is one of an electronic signal, optical signal, radio signal, or the computer-readable storage medium 1210, as described above.

The second node 112 may comprise an interface unit to facilitate communications between the second node 112 and other nodes or devices, e.g., the first node 111, the third node 113, the fourth node 114, another node, and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 12b. The second node 112 may comprise a processing circuitry 1205, e.g., one or more processors such as the processor 1205, in the second node 112 and the memory 1206. The second node 112 may also comprise a radio circuitry 1211, which may comprise e.g., the receiving port 1207 and the sending port 1208. The processing circuitry 1205 may be configured to, or operable to, perform the method actions according to FIG. 3, and/or FIGS. 7-8, in a similar manner as that described in relation to FIG. 12a. The radio circuitry 1211 may be configured to set up and maintain at least a wireless connection with the first node 111, the third node 113, the fourth node 114, another node, and/or another structure in the communications system 100.

Hence, embodiments herein also relate to the second node 112 operative for handling data, the second node 112 being operative to operate in the communications system 100. The second node 112 may comprise the processing circuitry 1205 and the memory 1206, said memory 1206 containing instructions executable by said processing circuitry 1205, whereby the second node 112 is further operative to perform the actions described herein in relation to the second node 112, e.g., in FIG. 3, and/or FIGS. 7-8.

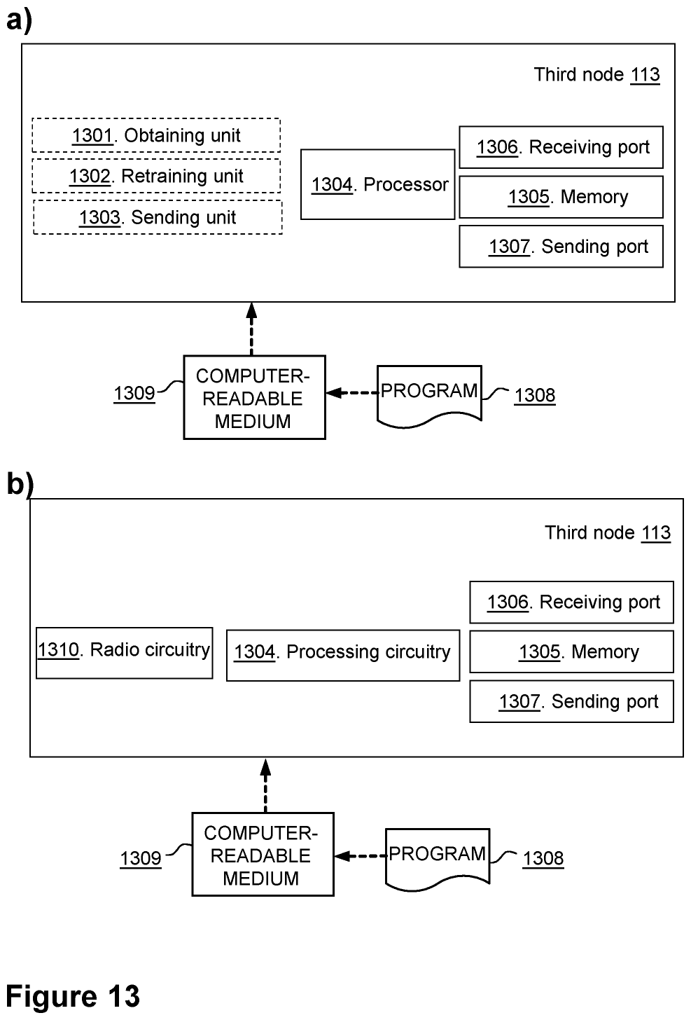

FIG. 13 depicts two different examples in panels a) and b), respectively, of the arrangement that the third node 113 may comprise to perform the method actions described above in relation to FIG. 4, and/or FIGS. 7-8. In some embodiments, the third node 113 may comprise the following arrangement depicted in FIG. 13a. The third node 113 may be understood to be for handling data. The third node 113 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the first node 111 and will thus not be repeated here. For example, the one or more first features may be configured to be used in the first predictive ML model of the event configured to be measured in the communications system 100 to explain the first variability of the event.

The third node 113 is configured to, e.g. by means of an obtaining unit 1301 within the third node 113 configured to, obtain, from the first node 111 configured to operate in the communications system 100, the second indication. The second indication is configured to comprise at least one of the following. According to a first option, the second indication is configured to comprise the one or more first sets of data. The one or more first sets of data may be configured to correspond to one or more first features configured to be used in the first predictive ML model of the event configured to be measured in the communications system 100 to explain the first variability of the event. The data in the one or more first sets of data may be configured to be annotated with the first indication. The first indication may be configured to indicate the respective representation of the distribution of the data in the one or more first sets of data. The obtaining may be configured to be performed before the one or more first sets of data may be configured to be used to train the first predictive ML model. According to a second option, the second indication may be configured to comprise the respective flag. The respective flag is configured to indicate there has been a change in the respective representation of the distribution of the one or more first sets of data configured to be obtained, with respect to the one or more second sets of data configured to have been previously collected. The one or more second sets of data may be configured to correspond to the one or more first features. The one or more second sets of data may be configured to have been used to train the first predictive ML model.

In some embodiments, the first indication may be configured to be comprised in one of: a) the field configured to lack encapsulation of one or more IP packets, b) the first signal configured to lack encapsulation, the first signal being configured to belong to core network signalling, c) the first signal, wherein the first signal may be configured to be the session identifier, and d) the second signal configured to lack encapsulation, the second signal being configured to belong to radio access network signalling.

According to a third option, the second indication may be configured to comprise the metric configured to indicate the change in the respective representation of the distribution.

The third node 113 is also configured to, e.g. by means of a retraining unit 1302 within the third node 113 configured to, retrain, using ML, the first predictive ML model based on the second indication configured to be obtained.

In some embodiments, the metric may be configured to indicate one of: a) the cosine similarity, b) the Kullback-Leibler divergence and c) the Jenson Shannon divergence.

The third node 113 may also be configured to, e.g. by means of a sending unit 1303 within the third node 113 configured to, send, to the first node 111, the third indication. The third indication may be configured to indicate to initiate collection of the one or more first sets of data. The obtaining of the second indication may be configured to be based on the third indication configured to be sent.

The third node 113 may be further configured to, e.g. by means of the obtaining unit 1301 within the third node 113 configured to, obtain, from the fourth node 114 configured to operate in the communications system 100, the second predictive ML model of the expected respective representation of the distribution of data sets configured to correspond to the one or more first features.

The third node 113 may be further configured to, e.g. by means of the sending unit 1303 within the third node 113 configured to, send the second predictive ML model to the first node 111. The obtaining of the second indication may be configured to be based on the second predictive ML model configured to be sent.

The third node 113 may be further configured to, e.g. by means of the sending unit 1303 within the third node 113 configured to, send, to the fourth node 114, the sixth indication. The sixth indication may be configured to indicate i) from the first indication, the source of a respective IP packet, first signal or second signal, and the destination of the respective IP packet, first signal or second signal, ii) the second predictive ML model, iii) the second features of the second predictive ML model configured to explain most of the second variability of the expected respective representation of the distribution of data sets configured to correspond to the one or more first features based on the threshold, and iv) the corresponding respective representation of the distribution data of the second features configured to explain most of the second variability, based on the threshold.

The embodiments herein may be implemented through one or more processors, such as a processor 1304 in the third node 113 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1305 comprising one or more memory units. The memory 1305 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, and/or another node, through a receiving port 1306. In some examples, the receiving port 1306 may be, for example, connected to one or more antennas in the third node 113. In other embodiments, the third node 113 may receive information from another structure in the communications system 100 through the receiving port 1306. Since the receiving port 1306 may be in communication with the processor 1304, the receiving port 1306 may then send the received information to the processor 1304. The receiving port 1306 may also be configured to receive other information.

The processor 1304 in the third node 113 may be further configured to transmit or send information to e.g., the first node 111, the second node 112, the fourth node 114, another node, and/or another structure in the communications system 100, through a sending port 1307, which may be in communication with the processor 1304, and the memory 1305.

Those skilled in the art will also appreciate that the units 1301-1303 described above may refer to a combination of analog and digital circuits, and/or one or more processors configured with software and/or firmware, e.g., stored in memory, that, when executed by the one or more processors such as the processor 1304, perform as described above. One or more of these processors, as well as the other digital hardware, may be included in a single ASIC, or several processors and various digital hardware may be distributed among several separate components, whether individually packaged or assembled into a SoC.

The units 1301-1303 described above may be the processor 1304 of the third node 113, or an application running on such processor.

Thus, the methods according to the embodiments described herein for the third node 113 may be respectively implemented by means of a computer program 1308 product, comprising instructions, i.e., software code portions, which, when executed on at least one processor 1304, cause the at least one processor 1304 to carry out the actions described herein, as performed by the third node 113. The computer program 1308 product may be stored on a computer-readable storage medium 1309. The computer-readable storage medium 1309, having stored thereon the computer program 1308, may comprise instructions which, when executed on at least one processor 1304, cause the at least one processor 1304 to carry out the actions described herein, as performed by the third node 113. In some embodiments, the computer-readable storage medium 1309 may be a non-transitory computer-readable storage medium, such as a CD ROM disc, a memory stick, or stored in the cloud space. In other embodiments, the computer program 1308 product may be stored on a carrier containing the computer program, wherein the carrier is one of an electronic signal, optical signal, radio signal, or the computer-readable storage medium 1309, as described above.

The third node 113 may comprise an interface unit to facilitate communications between the third node 113 and other nodes or devices, e.g., the first node 111, the second node 112, the fourth node 114, another node, and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 13b. The third node 113 may comprise a processing circuitry 1304, e.g., one or more processors such as the processor 1304, in the third node 113 and the memory 1305. The third node 113 may also comprise a radio circuitry 1310, which may comprise e.g., the receiving port 1306 and the sending port 1307. The processing circuitry 1304 may be configured to, or operable to, perform the method actions according to FIG. 4, and/or FIGS. 7-8, in a similar manner as that described in relation to FIG. 13a. The radio circuitry 1310 may be configured to set up and maintain at least a wireless connection with the first node 111, the second node 112, the fourth node 114, another node, and/or another structure in the communications system 100.

Hence, embodiments herein also relate to the third node 113 operative for handling data, the third node 113 being operative to operate in the communications system 100. The third node 113 may comprise the processing circuitry 1304 and the memory 1305, said memory 1305 containing instructions executable by said processing circuitry 1304, whereby the third node 113 is further operative to perform the actions described herein in relation to the third node 113, e.g., in FIG. 4, and/or FIGS. 7-8.

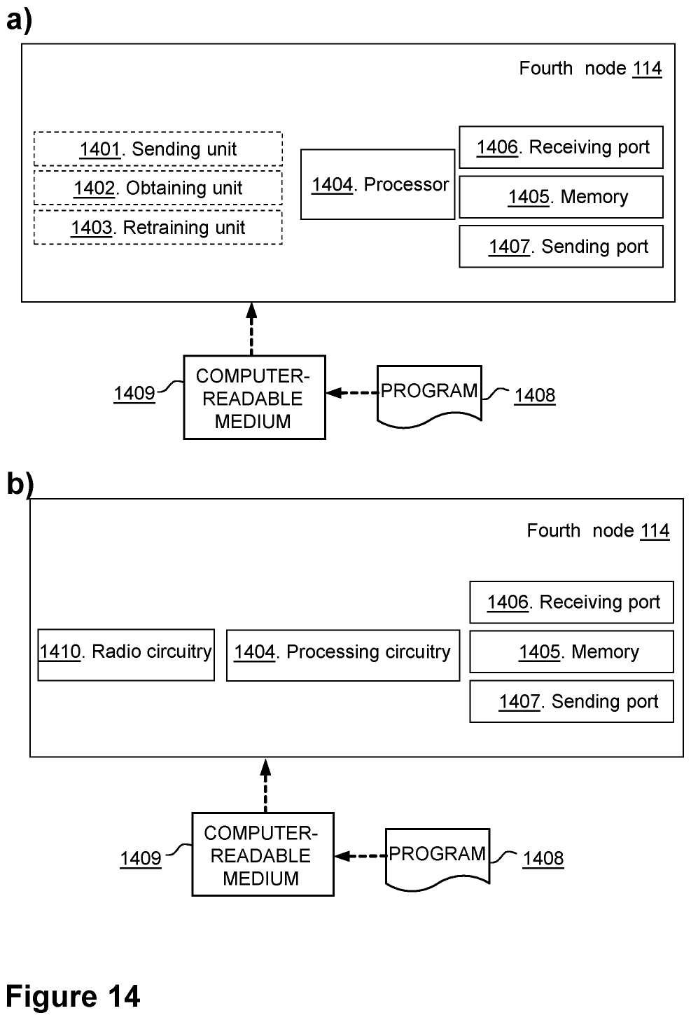

FIG. 14 depicts two different examples in panels a) and b), respectively, of the arrangement that the fourth node 114 may comprise to perform the method actions described above in relation to FIG. 5, and/or FIGS. 7-8. In some embodiments, the fourth node 114 may comprise the following arrangement depicted in FIG. 14a. The fourth node 114 may be understood to be for handling data. The fourth node 114 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111 and will thus not be repeated here. For example, the one or more first features may be configured to be used in the first predictive ML model of the event configured to be measured in the communications system 100 to explain the first variability of the event.

The fourth node 114 is configured to, e.g. by means of a sending unit 1401 within the fourth node 114 configured to, send, to the third node 113 configured to operate in the communications system 100, the second predictive ML model. The second predictive ML model is of the expected respective representation of the distribution of data sets configured to correspond to the one or more first features. The one or more first features are configured to be used in the first predictive ML model of the event configured to be measured in the communications system 100 to explain the first variability of the event.

The fourth node 114 is also configured to, e.g. by means of an obtaining unit 1402 within the fourth node 114 configured to, obtain, from the third node 113, the sixth indication. The sixth indication is configured to indicate the following. First, the sixth indication is configured to indicate the source of the respective IP packet, first signal or second signal, and the destination of the respective IP packet, of the one or more IP packets, first signal or second signal, in the first indication. The first indication is configured to indicate the respective representation configured to be obtained of the distribution of data in the one or more first sets of data. The one or more first sets of data are configured to correspond to the one or more first features. The data in the one or more first sets of data is configured to be annotated with the first indication. The one or more first sets of data are configured to comprise a respective flag. The respective flag is configured to indicate there has been a change in the respective representation of the distribution of the obtained one or more first sets of data. The change is with respect to one or more second sets of data configured to have been previously collected. The one or more second sets of data are configured to correspond to the one or more first features. The one or more second sets of data are configured to have been used to train the first predictive ML model. Second, the sixth indication is configured to indicate the second predictive ML model. Third, the sixth indication is configured to indicate the second features of the second predictive ML model. The second features are configured to explain most of the second variability of the expected respective representation of the distribution of data sets configured to correspond to the one or more first features, based on the threshold. Fourth, the sixth indication is configured to indicate the corresponding respective representation of the distribution data of the second features configured to explain most of the second variability, based on the threshold.

In some embodiments, the first indication may be configured to be comprised in one of: a) the field configured to lack encapsulation of one or more IP packets, b) the first signal configured to lack encapsulation, the first signal being configured to belong to core network signalling, c) the first signal, wherein the first signal may be configured to be the session identifier, and d) the second signal configured to lack encapsulation, the second signal being configured to belong to radio access network signalling.

The fourth node 114 is also configured to, e.g. by means of a retraining unit 1403 within the fourth node 114 configured to, retrain, using ML, the second predictive ML model based on the sixth indication configured to be obtained.

The fourth node 114 may be further configured to, e.g. by means of the obtaining unit 1402 within the fourth node 114 configured to, obtain, using ML, the second predictive ML model.

The fourth node 114 may be further configured to, e.g. by means of the sending unit 1401 within the fourth node 114 configured to, send, to the third node 113, the third indication configured to indicate to initiate collection of the one or more first sets of data.

The embodiments herein may be implemented through one or more processors, such as a processor 1404 in the fourth node 114 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the in the fourth node 114. One such carrier may be in the form of a CD ROM disc. It is however feasible with other data carriers such as a memory stick. The computer program code may furthermore be provided as pure program code on a server and downloaded to the fourth node 114.

The fourth node 114 may further comprise a memory 1405 comprising one or more memory units. The memory 1405 is arranged to be used to store obtained information, store data, configurations, schedulings, and applications etc. to perform the methods herein when being executed in the fourth node 114.

In some embodiments, the fourth node 114 may receive information from, e.g., the first node 111, the second node 112, the third node 113, and/or another node, through a receiving port 1406. In some examples, the receiving port 1406 may be, for example, connected to one or more antennas in the fourth node 114. In other embodiments, the fourth node 114 may receive information from another structure in the communications system 100 through the receiving port 1406. Since the receiving port 1406 may be in communication with the processor 1404, the receiving port 1406 may then send the received information to the processor 1404. The receiving port 1406 may also be configured to receive other information.

The processor 1404 in the fourth node 114 may be further configured to transmit or send information to e.g., the first node 111, the second node 112, the third node 113, another node, and/or another structure in the communications system 100, through a sending port 1407, which may be in communication with the processor 1404, and the memory 1405.

Those skilled in the art will also appreciate that the units 1401-1403 described above may refer to a combination of analog and digital circuits, and/or one or more processors configured with software and/or firmware, e.g., stored in memory, that, when executed by the one or more processors such as the processor 1404, perform as described above. One or more of these processors, as well as the other digital hardware, may be included in a single ASIC, or several processors and various digital hardware may be distributed among several separate components, whether individually packaged or assembled into a SoC.

The units 1401-1403 described above may be the processor 1404 of the fourth node 114, or an application running on such processor.

Thus, the methods according to the embodiments described herein for the fourth node 114 may be respectively implemented by means of a computer program 1408 product, comprising instructions, i.e., software code portions, which, when executed on at least one processor 1404, cause the at least one processor 1404 to carry out the actions described herein, as performed by the fourth node 114. The computer program 1408 product may be stored on a computer-readable storage medium 1409. The computer-readable storage medium 1409, having stored thereon the computer program 1408, may comprise instructions which, when executed on at least one processor 1404, cause the at least one processor 1404 to carry out the actions described herein, as performed by the fourth node 114. In some embodiments, the computer-readable storage medium 1409 may be a non-transitory computer-readable storage medium, such as a CD ROM disc, a memory stick, or stored in the cloud space. In other embodiments, the computer program 1408 product may be stored on a carrier containing the computer program, wherein the carrier is one of an electronic signal, optical signal, radio signal, or the computer-readable storage medium 1409, as described above.

The fourth node 114 may comprise an interface unit to facilitate communications between the fourth node 114 and other nodes or devices, e.g., the first node 111, the second node 112, the third node 113, another node, and/or another structure in the communications system 100. In some particular examples, the interface may, for example, include a transceiver configured to transmit and receive radio signals over an air interface in accordance with a suitable standard.

In other embodiments, the fourth node 114 may comprise the following arrangement depicted in FIG. 14b. The fourth node 114 may comprise a processing circuitry 1404, e.g., one or more processors such as the processor 1404, in the fourth node 114 and the memory 1405. The fourth node 114 may also comprise a radio circuitry 1410, which may comprise e.g., the receiving port 1406 and the sending port 1407. The processing circuitry 1404 may be configured to, or operable to, perform the method actions according to FIG. 5, and/or FIGS. 7-8, in a similar manner as that described in relation to FIG. 14a. The radio circuitry 1410 may be configured to set up and maintain at least a wireless connection with the first node 111, the second node 112, the third node 113, another node, and/or another structure in the communications system 100.

Hence, embodiments herein also relate to the fourth node 114 operative for handling data, the fourth node 114 being operative to operate in the communications system 100. The fourth node 114 may comprise the processing circuitry 1404 and the memory 1405, said memory 1405 containing instructions executable by said processing circuitry 1404, whereby the fourth node 114 is further operative to perform the actions described herein in relation to the fourth node 114, e.g., in FIG. 5, and/or FIGS. 7-8.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP, Rel. 17, TR 37.817 “Study on enhancement for data collection for NR and ENDC”
2. https://hal.archives-ouvertes.fr/hal-02615107/document
3. https://arxiv.org/pdf/1709.02656.pdf
4. Mnih, V., Kavukcuoglu, K., Silver, D. et al. Human-level control through deep reinforcement learning. Nature 518, 529-533 (2015). https://doi.org/10.1038/nature14236.

1-22. (canceled)

23. A first node, for handling data, the first node being configured to operate in a communications system, the first node being further configured to:
obtain, from a second node configured to operate in the communications system, one or more first sets of data configured to correspond to one or more first features configured to be used in a first predictive machine learning (ML) model of an event configured to be measured in the communications system to explain a first variability of the event, the data in the one or more first sets of data being configured to be annotated with a first indication, the first indication being configured to indicate a respective representation of a distribution of the data in the one or more first sets of data, and the obtaining being configured to be performed before the one or more first sets of data are configured to be used to train the first predictive ML model, the second node being configured to be a producer of the one or more first sets of data;
determining, based on the first indication, whether or not there has been a change in a respective representation of the distribution of the one or more first sets of data configured to be obtained, with respect to one or more second sets of data configured to be previously collected, wherein the one or more second sets of data are configured to correspond to the one or more first features configured to be used in the first predictive ML model, the one or more second sets of data being configured to have been used to train the first predictive ML model, and wherein the determining is configured to be performed before the one or more first sets of data are configured to be used to train the first predictive ML model;
determine whether or not to send the one or more first sets of data to a third node configured to operate in the communications system, in response to the determining of whether or not there has been a change in the respective representation of the distribution; and
send a second indication of the one or more first sets of data to the third node in response to the determining of whether or not to send the one or more first sets of data.

24. The first node of claim 23, wherein the first indication is configured to be comprised in one of:
a field configured to lack encapsulation of one or more Internet Protocol (IP) packets,
a first signal configured to lack encapsulation, the first signal being configured to belong to core network signalling,
the first signal, wherein the first signal is configured to be a session identifier, and
a second signal configured to lack encapsulation, the second signal being configured to belong to radio access network signalling.

25. The first node of claim 23, wherein the sending is configured to comprise at least one of:
with the proviso that there has been no change in the respective representation of the distribution of the one or more first sets of data configured to be obtained, sending the second indication configured to comprise the one or more first sets of data,
with the proviso that there has been a change in the respective representation of the distribution due to faulty data of the one or more first sets of data configured to be obtained, refraining from sending the second indication configured to comprise the one or more first sets of data, and
with the proviso that there has been a change in the respective representation of the distribution of the one or more first sets of data configured to be obtained, and the data is not faulty, sending the second indication, the second indication being configured to comprise at least one of:
the one or more first sets of data,
a respective flag configured to indicate there has been a change in the respective representation of the distribution of the one or more first sets of data configured to be obtained, and
a metric configured to indicate the change in the respective representation of the distribution of the one or more first sets of data configured to be obtained.

26. The first node of claim 25, wherein with the proviso that there has been a change in the respective representation of the distribution of the one or more first sets of data configured to be obtained, and the data is not faulty, the one of the one or more first sets of data and the respective flag is configured to be sent with one of:
a lower priority than other data, and
a delay; and
the metric is configured to indicate one of:
cosine similarity,
Kullback-Leibler divergence and
Jenson Shannon divergence.

27. (canceled)

28. The first node of claim 23, being further configured to:
obtain, from the third node, a third indication configured to indicate to initiate collection of the one or more first sets of data; and
initiate collection of the one or more first sets of data based on the third indication configured to be obtained, wherein:
the initiating collection is configured to comprise sending a fourth indication to the second node, the fourth indication being configured to instruct the second node to collect the one or more first sets of data, and
the obtaining of the one or more first sets of data is configured to be based on the fourth indication configured to be sent.

29. (canceled)

30. The first node of claim 25, wherein with the proviso there has been a change in the respective representation of the distribution, due to faulty data, the first node is further configured to:
send a fifth indication to the second node configured to indicate the detection of faulty data in the one or more first sets of data.

31. The first node of claim 23, wherein the first node is further configured to:
obtain, from the third node, a second predictive ML model of an expected respective representation of the distribution of data sets configured to correspond to the one or more first features, and wherein the determining of whether or not there has been a change in the respective representation of the distribution is configured to be performed using the second predictive ML model.

32. A second node, for handling data, the second node being configured to operate in a communications system, the second node being further configured to:
obtain a fourth indication from a first node configured to operate in the communications system, the fourth indication being configured to instruct the second node to collect one or more first sets of data; and
send, to the first node, the one or more first sets of data, the sending being configured to be performed before the one or more first sets of data are used to train any predictive machine learning (ML) model, the second node being configured to be a producer of the one or more first sets of data, wherein the data in the one or more first sets of data is configured to be annotated with a first indication, the first indication being configured to indicate a respective representation of a distribution of the data in the one or more first sets of data.

33. The second node of claim 32, wherein the first indication is configured to be comprised in one of:
a field configured to lack encapsulation of one or more Internet Protocol (IP) packets,
a first signal configured to lack encapsulation, the first signal being configured to belong to core network signalling,
the first signal, wherein the first signal is configured to be a session identifier, and
a second signal configured to lack encapsulation, the second signal being configured to belong to radio access network signalling.

34. The second node of claim 32, wherein the second node is further configured to:
collect the one or more first sets of data based on the fourth indication configured to be obtained, and
annotate the one or more first sets of data with the first indication.

35. The second node of claim 32, wherein the second node is further configured to:
obtain a fifth indication from the first node, the fifth indication being configured to indicate detection of faulty data in the one or more first sets of data.

36. A third node, for handling data, the third node being configured to operate in a communications system, the third node being further configured to:
obtain, from a first node configured to operate in the communications system, a second indication being configured to comprise at least one of:
one or more first sets of data, the one or more first sets of data being configured to correspond to one or more first features configured to be used in a first predictive machine learning (ML) model of an event configured to be measured in the communications system to explain a first variability of the event, the data in the one or more first sets of data being configured to be annotated with a first indication, the first indication being configured to indicate a respective representation of a distribution of the data in the one or more first sets of data, the obtaining being configured to be performed before the one or more first sets of data are configured to be used to train the first predictive ML model,
a respective flag configured to indicate there has been a change in the respective representation of the distribution of the one or more first sets of data configured to be obtained, with respect to one or more second sets of data configured to have been previously collected, wherein the one or more second sets of data are configured to correspond to the one or more first features and wherein the one or more second sets of data are configured to have been used to train the first predictive ML model, and
a metric configured to indicate the change in the respective representation of the distribution; and
retrain, using machine learning, the first predictive ML model based on the second indication configured to be obtained.

37. The third node of claim 36, wherein the first indication is configured to be comprised in one of:
a field configured to lack encapsulation of one or more Internet Protocol (IP) packets,
a first signal configured to lack encapsulation, the first signal being configured to belong to core network signalling,
the first signal, wherein the first signal is configured to be a session identifier, and
a second signal configured to lack encapsulation, the second signal being configured to belong to radio access network signalling.

38. The third node of claim 36, wherein the metric is configured to indicate one of:
cosine similarity,
Kullback-Leibler divergence and
Jenson Shannon divergence.

39. The third node of claim 36, being further configured to:
send, to the first node, a third indication configured to indicate to initiate collection of the one or more first sets of data, wherein the obtaining of the second indication is configured to be based on the third indication configured to be sent.

40. The third node of claim 36, wherein the third node is further configured to:
obtain, from a fourth node configured to operate in the communications system, a second predictive ML model of an expected respective representation of the distribution of data sets configured to correspond to the one or more first features; and
send the second predictive ML model to the first node, and wherein the obtaining of the second indication is configured to be based on the second predictive ML model configured to be sent.

41. The third node of claim 40, being further configured to:
send, to the fourth node, a sixth indication configured to indicate:
from the first indication, a source of a respective Internet Protocol (IP) packet, first signal or second signal, and a destination of the respective IP packet, first signal or second signal,
the second predictive ML model,
second features of the second predictive ML model configured to explain most of a second variability of the expected respective representation of the distribution of data sets configured to correspond to the one or more first features based on a threshold, and
a corresponding respective representation of a distribution data of the second features configured to explain most of the second variability, based on the threshold.

42. A fourth node, for handling data, the fourth node being configured to operate in a communications system, the fourth node being further configured to:
send, to a third node configured to operate in the communications system, a second predictive machine learning (ML) model of an expected respective representation of a distribution of data sets configured to correspond to one or more first features configured to be used in a first predictive ML model of an event configured to be measured in the communications system to explain a first variability of the event,
obtain, from the third node, a sixth indication configured to indicate:
a source of a respective Internet Protocol (IP), IP, packet, first signal or second signal, and a destination of the respective IP packet, of one or more IP packets, first signal or second signal, in a first indication, the first indication being configured to indicate an respective representation configured to be obtained of a distribution of data in one or more first sets of data, the one or more first sets of data being configured to correspond to the one or more first features, the data in the one or more first sets of data being configured to be annotated with the first indication, the one or more first sets of data being configured to comprise a respective flag configured to indicate there has been a change in the respective representation of the distribution of the obtained one or more first sets of data, with respect to one or more second sets of data configured to have been previously collected, wherein the one or more second sets of data are configured to correspond to the one or more first features and wherein the one or more second sets of data are configured to have been used to train the first predictive ML model,
the second predictive ML model,
second features of the second predictive ML model configured to explain most of a second variability of the expected respective representation of the distribution of data sets configured to correspond to the one or more first features, based on a threshold, and
a corresponding respective representation of a distribution data of the second features configured to explain most of the second variability, based on the threshold; and
retrain, using machine learning, the second predictive ML model based on the sixth indication configured to be obtained.

43. The fourth node of claim 42, wherein the first indication is configured to be comprised in one of:
a field configured to lack encapsulation of one or more Internet Protocol packets,
a first signal configured to lack encapsulation, the first signal being configured to belong to core network signalling,
the first signal, wherein the first signal is configured to be a session identifier, and
a second signal configured to lack encapsulation, the second signal being configured to belong to radio access network signalling.

44. The fourth node of claim 42, wherein the fourth node is further configured to at least one of:
obtain, using machine learning, the second predictive ML model, and
send, to the third node, a third indication configured to indicate to initiate collection of the one or more first sets of data.
